(19) United States
(12) Patent Application Publication
(10) Pub. No.: US 2026/0347728 A1
(43) Pub. Date: Nov. 5, 2026

(54) SELF-REGENERATING CANDLE SYSTEM WITH MODULAR CONFIGURATIONS

(71) Applicant: ReGen Candle Company Ltd, Birmingham (GB)

(72) Inventor: Alan Amron, Quogue, NY (US)

(73) Assignee: ReGen Candle Company Ltd, Birmingham (GB)

(21) Appl. No.: 19/567,101

(22) Filed: Mar. 14, 2026

Related U.S. Application Data
(60) Provisional application No. 63/798,012, filed on May 1, 2025.
(60) Provisional application No. 63/915,595, filed on Nov. 11, 2025.
(60) Provisional application No. 63/927,629, filed on Nov. 30, 2025.

(51) Int. Cl. C11C 5/02; F23D 3/16

(52) U.S. Cl. CPC C11C 5/023; F23D 3/16

(57) ABSTRACT

A self-regenerating candle apparatus, methods, and systems in multiple embodiments addresses different markets. An embodiment operates through gravity without electrical power, utilizing an aluminum platform with multi-spoke radial design, a center wick positioning member forming a pre-positioned wick channel, and a food-grade-like plastic collector chamber. An embodiment adds heating elements, flame and drip detection, and microcontroller-based temperature management achieving substantially complete wax recovery. Other options include a jar candle votive, tea light, and taper candles through bottomless jar and candles with grid structures or lip enabling wax drainage into collection chambers, creating a refill-based business model. A funnel component optionally channels wax from larger platforms to smaller collection chambers. Optional pre-waxed wick assemblies with retention discs facilitate wick insertion. Interchangeable mold inserts enable decorative shaped and sized candles. The self-cleaning thermal effect melts residual wax through flame-heated aluminum during final burn with or without requiring electrical heating in passive versions.

### CROSS-REFERENCE TO RELATED APPLICATIONS

This application claims priority to:
U.S. Provisional Patent Application No. 63/798,012, filed May 1, 2025
U.S. Provisional Patent Application No. 63/915,595, filed Nov. 11, 2025
U.S. Provisional Patent Application No. 63/927,629, filed Nov. 30, 2025

The entire contents of these provisional applications are incorporated herein by reference.

### STATEMENT REGARDING FEDERALLY SPONSORED RESEARCH OR DEVELOPMENT

Not Applicable

### FIELD OF THE INVENTION

The present invention relates generally to candle accessories and wax recovery systems, and more particularly to modular apparatus and methods for collecting, forming, and regenerating new candles from drip wax, available in multiple configurations including: (1) a mass-market passive gravity-based system requiring no electrical power, (2) a specialty market electronically-heated system with intelligent flame and/or drip detection, and (3) variations utilizing different material combinations including aluminum, food-grade-like plastics, glass, and non-stick coatings.

### BACKGROUND OF THE INVENTION

Traditional pillar and taper candles produce significant amounts of drip wax during normal burning. In conventional candles, a significant portion of candle wax is lost to dripping, representing both economic waste and cleanup burden for consumers. This drip wax typically runs down the side of the candle, accumulates on candle holders and surfaces, and creates unsightly messes that are difficult to clean. Aside from the dripping wax, every candle leaves a residual amount of wax when the candle wick burns out. This invention substantially eliminates wasted unused wax.

Prior art solutions have attempted to address candle dripping through various means including drip catchers, bobeches, and candle followers. However, these solutions merely collect wax without providing means to reuse it. The collected wax typically solidifies in irregular shapes without a wick hole, rendering it unsuitable for burning as a new candle without extensive reprocessing.

Furthermore, existing wax collection devices are often made from materials that are expensive to manufacture, fragile, difficult to clean, and from which solidified wax is difficult to remove. Some prior art systems have attempted automated wick insertion during the wax collection process, requiring complex motorized delivery systems, continuous user monitoring, and mechanical components that increase cost and failure rates.

The present invention differs from known prior art in several fundamental respects that establish patentability: Some prior art systems employ a pre-positioned wick in a collection tube, with natural wax melting down into the tube around the pre-existing wick. The new candle is removed by pulling on the wick, which serves as both channel-forming element and removal handle. The Shine system has no heating elements, no thermal self-cleaning mechanism, and requires the wick to remain intact during wax solidification. In contrast, the present invention employs post-formation wick insertion using a thermally conductive metal post that is removable after solidification. The metal post provides triple-function integration: (1) structural support during formation, (2) passive thermal conduction enabling self-cleaning, and (3) precise wick channel formation through physical displacement. The wick plays no role in candle removal, which occurs via separable chamber with squeeze-release or tap-out mechanisms exploiting wax shrinkage. The spoke-based platform design provides substantial open drainage and viewing area compared to known prior art. Other related prior art discloses a candle warmer system with heating elements (500, 600) used to re-melt an already-formed reusable candle for secondary burning. The system collects wax into a container with pre-positioned wick, then applies heat after formation to liquefy the solid candle for reburning. In contrast, the present invention applies heat (in the heated embodiment) for two distinct functions during the burn cycle: (1) guiding molten wax through drainage channels during active burning to prevent premature solidification, and (2) driving residual wax extraction via IR-detected flame extinction after wick burnout. This dual-function heating is integral to drainage optimization during initial candle burning, achieving substantially complete wax recovery in a single continuous cycle. The post-formation remelting approach requires multiple melt/remelt cycles and does not teach or suggest heat-assisted drainage during initial burn or IR-automated final extraction. Additionally, other prior art relies on motorized or complex mechanical wick delivery systems during wax formation, whereas the present invention employs simple post-formation wick insertion after the wick positioning member is removed, eliminating mechanical complexity and enabling user selection of wick type, diameter, and material after candle formation is complete. These fundamental operational and structural differences establish the non-obviousness of the present invention over the known prior art.

There exists a need for a candle regeneration system that: (1) operates passively without electrical power for mass-market applications, (2) automatically collects wax through gravity and non-stick surfaces, (3) allows simple post-formation wick insertion rather than complex during-formation insertion, (4) provides optional intelligent heating for enhanced wax recovery in specialty applications, (5) achieves high wax recovery rates, (6) requires minimal user interaction, (7) utilizes food-grade-like, non-toxic materials, and (8) can be manufactured at various price points to address different market segments.

### SUMMARY OF THE INVENTION

The present invention provides a self-regenerating candle system in multiple embodiments addressing different market segments and use cases. All embodiments share core innovations including: (1) a minimal-interference platform with spaced support element design permitting aesthetic visibility, (2) a center wick positioning member that forms a pre-positioned wick channel during wax solidification, (3) a removable wax collector chamber with food-grade-like non-stick properties, and (4) a twist-on connection system using bayonet-style twist-lock mechanism for easy assembly and removal.

### EXAMPLE CONFIGURATION OF PASSIVE EMBODIMENT

The embodiment operates entirely through gravity and mechanical components without any electrical power, batteries, or electronics. This example includes:
An aluminum platform with 5-spoke radial design (72° spacing) providing substantial open drainage and viewing area
A center aluminum wick positioning member, either with internal channel or solid construction
A food-grade-like plastic wax collector chamber with inherent or applied non-stick properties
Optional PTFE coating on aluminum components for enhanced release
Twist-on bayonet-style twist-lock connection between platform and collector chamber - Wax recovery rate: Enhanced passive collection efficiency

### EXAMPLE CONFIGURATION OF HEATED EMBODIMENT

This embodiment includes some or all of the features of the passive embodiment version plus:
Integrated dual-zone heating element (nichrome wire embedded in platform)
IR flame detection sensor with multi-state logic (burning/extinguished/finished)
IR drip detection sensor(s) with multi-state logic (no drip/drip)
Microcontroller-based temperature management system
Two operating modes:
   Drip maintenance mode during burning and residual elimination mode after extinction
   PTFE-coated aluminum components preferred (optional) for heated operation
   Optional transparent borosilicate glass collector with FVMQ coating
   Battery or USB-powered operation
   Wax recovery rate:
      Substantially enhanced through heat-assisted extraction

### SELF-CLEANING THERMAL EFFECT

A significant benefit of the aluminum (or other heat conducting material) construction, observed during testing, is that during the final burn phase, when the wick reaches its end, the flame directly heats the aluminum platform and wick positioning member assembly. This thermal energy conducts through the metal components, melting any residual wax that would otherwise remain as waste. The melted residual wax flows through perforations in the platform (created by the spoke design and bottom drainage holes) into the collector chamber below, achieving substantially complete wax recovery without requiring electrical heating in the mass-market version.

This self-cleaning effect was discovered during prototype testing and represents an inherent advantage of the minimal-interference aluminum platform design combined with drainage perforations at the bottom of the candle cup area.

### FOOD-GRADE-LIKE NON-STICK MATERIALS

In certain embodiments, one or more wax-contacting surfaces of the wax-bearing support structure, spaced arms, drainage openings, wax-collecting chamber, or associated components may comprise a low-adhesion or low surface-energy surface treatment configured to reduce molten wax accumulation and promote release of wax during operation.

Such surface treatments may include, without limitation: fluoropolymer coatings including polytetrafluoroethylene (PTFE); FEP or related fluorinated polymers; ceramic-based non-stick coatings; silicone-based coatings; anodized metal surfaces; polished or treated metallic substrates; plasma-treated surfaces; or any other coating or surface modification that reduces wax adhesion relative to untreated metal surfaces. The device is not limited to PTFE, and any material or surface treatment that reduces wax adhesion and promotes gravitational flow of molten wax into the wax-collecting chamber may be used. Not all versions require food grade compatibility non-stick materials. Some users may prefer food-grade-like, non-toxic materials for components that contact molten wax.

Examples of Material Options May Include:
FVMQ (Fluorosilicone) coating on glass:
   Optical clarity with non-stick properties
   Food-grade-like polypropylene (PP):
      Inherent non-stick properties, suitable for collector chamber
      Anodized aluminum:
         Type II or Type III anodization for durability

Material Selection Criteria May Include:
Heat resistance to 260° C minimum
Non-stick properties (contact angle >110°)
Wax compatibility (no chemical interaction)
Durability for 50+ regeneration cycles
FDA/EU food-grade-like quality
Cost-effectiveness for target market segment

### POST-FORMATION WICK INSERTION

Unlike prior art requiring complex wick delivery during wax solidification, the present invention utilizes a fixed wick positioning member that remains in place as wax solidifies around it, creating a pre-positioned wick channel. After the regenerated candle is removed from the collector chamber (facilitated by wax shrinkage upon cooling and non-stick surfaces), a pre-waxed wick assembly is simply inserted into the formed channel, eliminating the need for motorized wick delivery systems.

### EXAMPLES OF MODULAR SCALABILITY

The system is designed for multiple size configurations, such as commonly available 3” to 7” diameter. The dimensions of the device can vary widely in size and the dimensions are intended to compatible with a pre-selected candle and candle style. Platform size is essentially limitless.

Similarly, collector chamber depths are commonly 1"-4" depending on desired regenerated candle size, but may be any size corresponding to the dimensions of the candle and other elements.

Universal wick positioning member diameter: is approximately 6mm in diameter (wick-sized), typical regenerated candle diameter approximately 2" diameter at base determined by chamber geometry for standardized regenerated candle regardless of platform size. Other dimensions compatible with the other components fall within the inventive scope.

### BRIEF DESCRIPTION OF THE DRAWINGS

FIG. 1 is an exploded view of an example of a candle regeneration system configured for use with a pillar candle, showing the base ring (100), wax-collecting chamber (30) with tapered lower wax collector (195), twist-on collar (40), and platform (10) having five spaced arms (12) at 72-degree intervals providing substantial open drainage and viewing area. The platform includes an outer rim (14), center hub (16), and a downwardly projecting, annular, tapered candle-receiving collar (24) positioned beneath the spaced arms, sized nominally for a one-inch candle and tapered to accommodate dimensional variations among candles from different manufacturers. A wick positioning member (18) extends vertically through the assembly creating a wick channel. A pillar candle (150) with wick (151) and flame (152) is positioned above the platform. Molten wax drips are shown draining through gaps between the spokes into the collection chamber below.

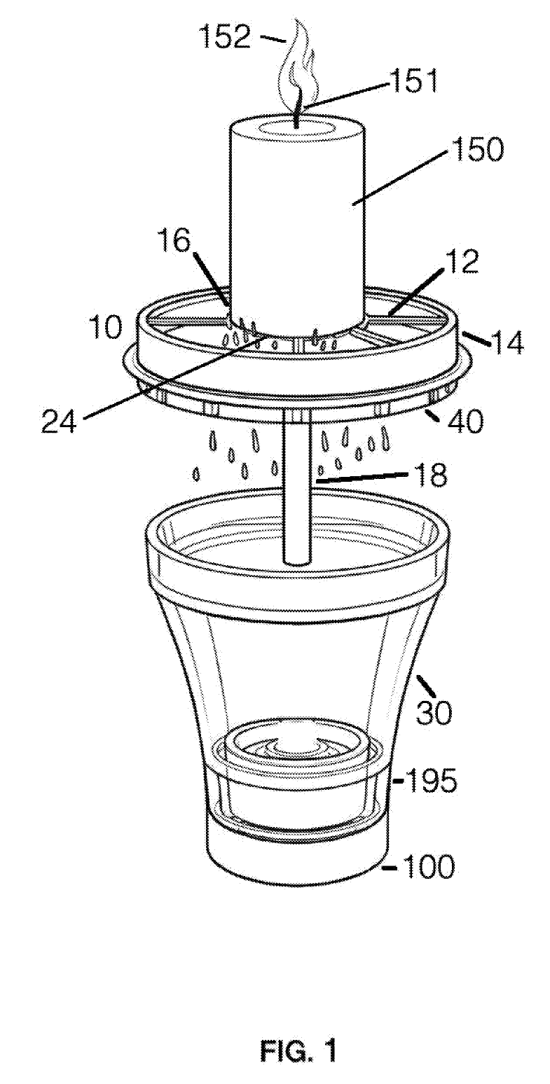

Shown in this example are platform (10), spokes (12), outer rim (14), hub (16), wick positioning member (18), twist-on collar (40), wax-collecting chamber (30), tapered wax collector (195), base ring (100). Shows gravity-driven wax drip path from pillar candle through spoke gaps into collection chamber.

FIG. 2 is an exploded perspective view of the tea candle assembly showing the tea candle (160) with integrated spoke channels (162), platform (10), wick positioning member (18), wax-collecting chamber (30), and base ring (100), with bold arrows showing wax flow path downward through platform openings into collection chamber.

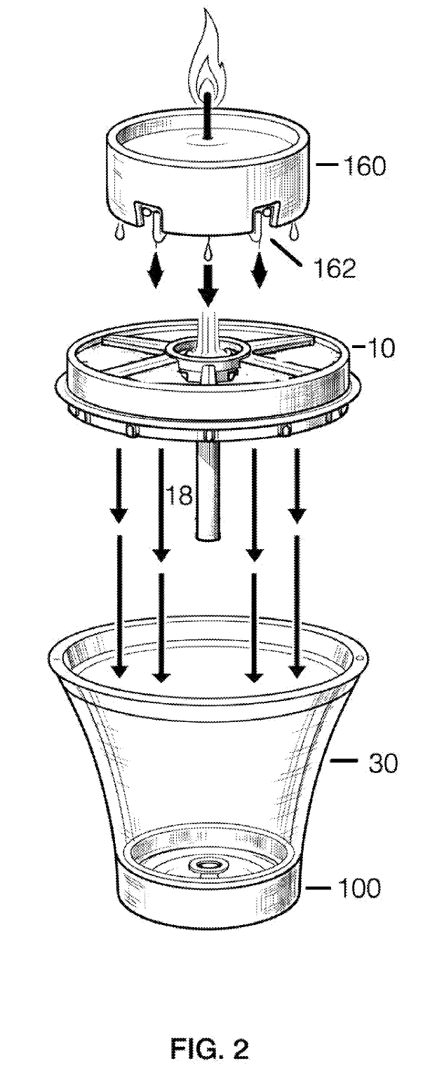

FIG. 3 is a perspective view of a jar candle assembly — glass jar candle (170) with wax (172) and integrated spoke channels (173) seated on platform (10) with twist-on collar (40), wick positioning member (18), wax-collecting chamber (30), and base ring (100).

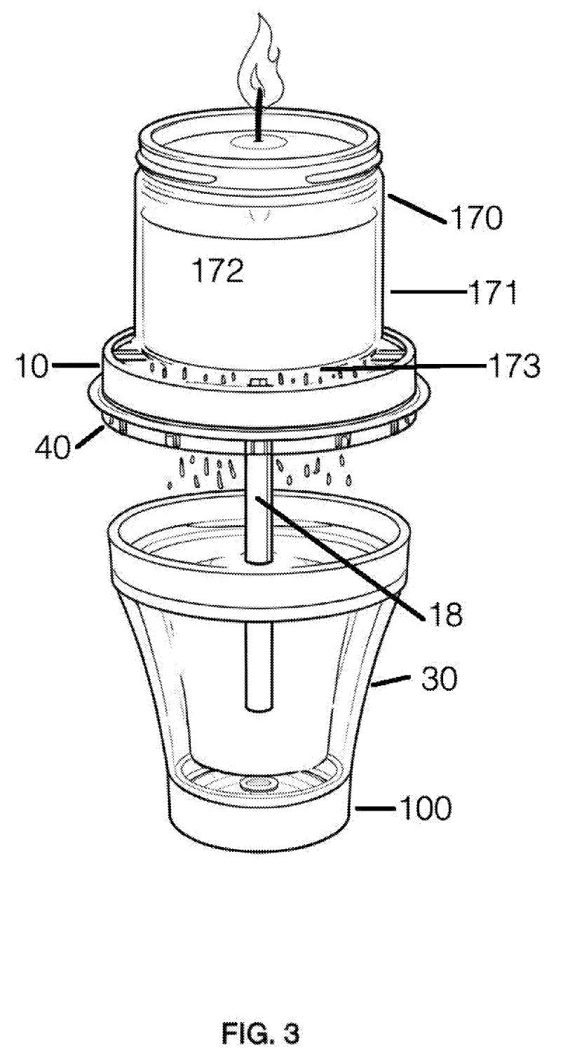

FIG. 4 shows the bayonet-style twist-lock connection detail between the platform (10) and the wax-collecting chamber (30) via twist-on collar (40). The bayonet-style or bayonet engagement mechanism allows tool-free assembly and disassembly for cleaning and candle removal. Internal threads or locking tabs are shown in cross-section, illustrating the mechanical interface that secures the upper platform to the lower collection chamber while maintaining a sealed wax pathway with wax flow arrows. The collection chamber is separable from the platform independent of wick presence.

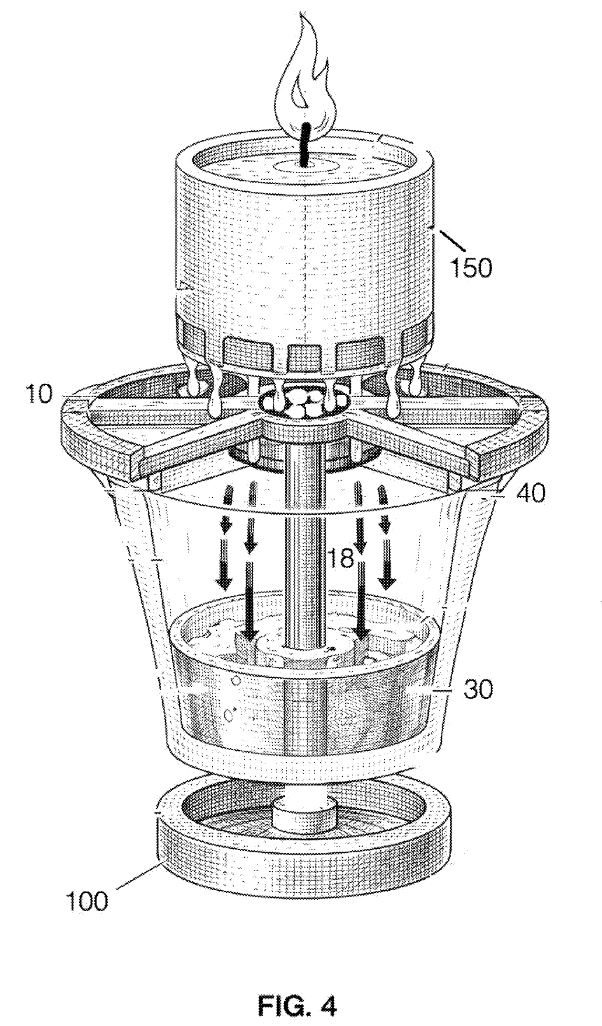

Shown in this example are pillar candle (150), platform (10), twist-on collar (40), wick positioning member (18), wax-collecting chamber (30), base ring (100). Shows complete assembled cross-section with wax flow arrows, gravity-driven drainage path, and wax solidifying around wick positioning member.

FIG. 5 is a perspective top view of the platform (10) showing the circular outer rim (14), five spaced arms or spokes (12) extending radially inward from the rim at approximately 72-degree intervals (but could vary in number and spacing), central hub (16), and the downwardly projecting candle-receiving collar (24) at the hub center through which the wick positioning member (18) extends. The gaps between the spokes define the drainage openings through which molten wax flows by gravity into the wax-collecting chamber below. Wax drip droplets are shown falling from the outer rim perimeter, illustrating the gravity-driven wax recovery path in the passive embodiment. This figure applies to both the mass-market passive embodiment and the heated embodiment, as the platform geometry is common to both configurations.

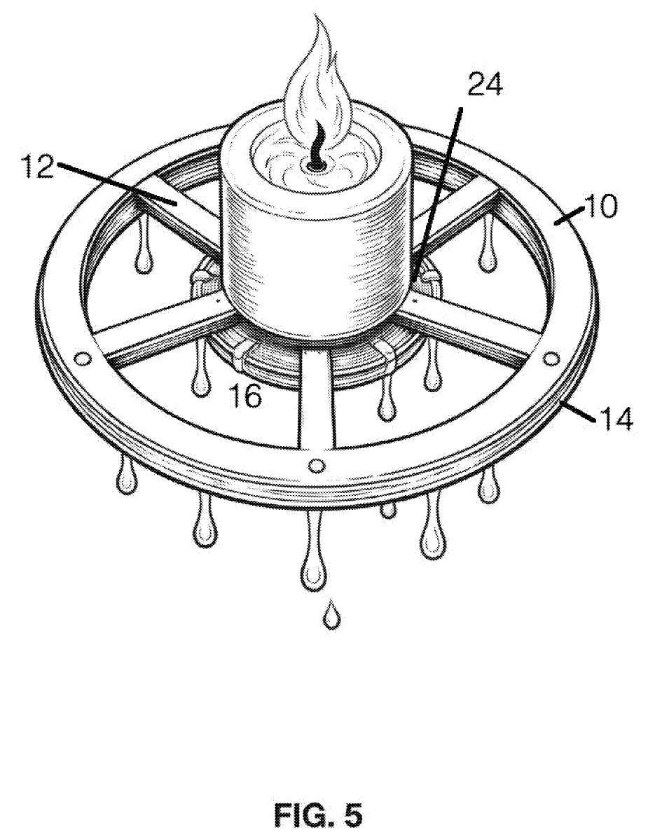

Shown in this example are platform (10), spokes (12), outer rim (14), hub (16), candle-receiving collar (24). Top perspective showing pillar candle seated in hub with wax dripping from spoke edges and around the full perimeter of the outer rim.

FIG. 6 shows perspective view of platform (10), twist-on collar (40), wax-collecting chamber (30), control circuit board (203), microcontroller (71), rechargeable battery (73), USB-C port (72), electronic base housing (200). Electronic components of the heated smart version are shown below collection chamber.

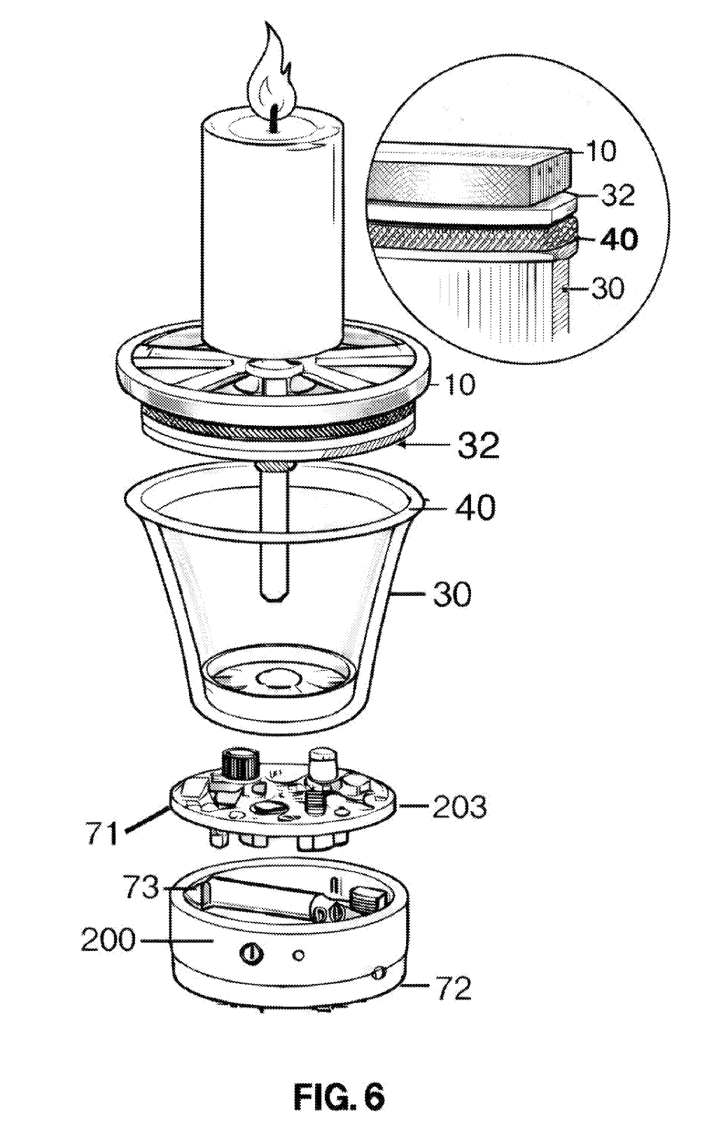

FIG. 7 is a perspective view of a tea candle consumable (160) with centrally embedded wick (161) and integrated spoke channels molded into the bottom at equal intervals. This view shows the cylindrical tea candle with flame, while a bottom view illustrates the radial channels (4mm wide, 3-4mm deep) extending from outer edge toward center. The drainage structure is formed entirely within the wax without any metal cup, enabling molten wax to bypass the platform surface and drain directly into the collection chamber, achieving substantially complete wax recovery compared to 0 % with conventional tea candles.

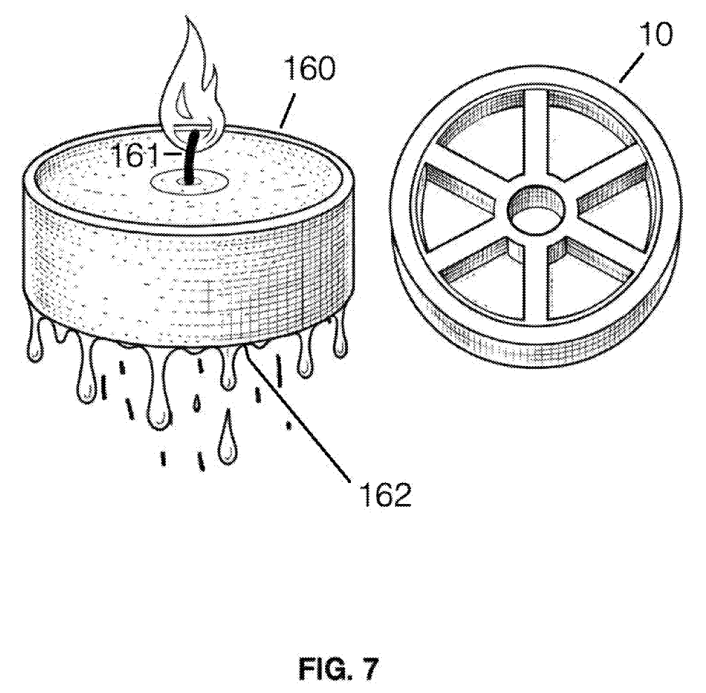

Shown in this example are tea candle (160) with embedded wick (161) and wax drips, shown alongside open-bottom platform with five spokes and central hub. Demonstrates the tea candle consumable and compatible platform configuration.

FIG. 8A is an enlarged cross-sectional detail view of the smart heated platform (20) showing the integration of flame sensor components, including a detailed cutaway depicting one flame detection sensor (26) positioned in a sensor cavity (83) with an optional sensor window (84) providing optical or other detection access to the flame, with the sensor's field-of-view or detection zone (85) extending upward to cover the flame detection zone (86) above the platform, electrical connection path (87) routing sensor signals to the electronics platform (70) below, and an additional empty sensor cavity (83) shown on the opposite side labeled "for optional additional sensor" demonstrating the platform's capacity to accommodate multiple sensors in various configurations.

Shown in this example are smart heated platform (20), flame detection sensor (26), sensor cavity (83), sensor window (84), field-of-view (85), flame detection zone (86), electrical connection path (87), drip detection field-of-view (88). Top-right inset shows both sensor (26) and drip sensor (27) positions relative to flame center.

FIG. 8B is a top plan view of the smart heated platform (20) showing the flame detection sensor arrangement with one primary flame detection sensor positioned at the top of the platform shown in solid lines, additional optional flame detection sensor positions (26) distributed around the platform perimeter shown in phantom lines indicating these are optional configurations, with a field-of-view cone (85) extending from the primary sensor and optional corresponding cones associated with phantom sensor positions, all converging on the central flame detection zone (86) which encompasses the candle flame at the center of the platform, demonstrating that the system may be configured with one sensor for basic operation or with multiple sensors for enhanced detection reliability and coverage, with the phantom representation clearly indicating the optional nature of additional sensors beyond the minimum single-sensor embodiment.

Shown in this example are flame detection sensors (26) shown at primary position; optional additional sensor positions (26) shown in phantom (dashed) lines distributed around platform perimeter. Detection cones (85) converge on central flame detection zone (86).

FIG. 8C is a system block diagram showing the complete electronics architecture and control flow of the smart heated platform embodiment, illustrating the interconnections between major subsystems including: the flame detection sensor(s) (26) and drip detection sensor(s) (27) providing flame and drip detection signals; the thermal management circuitry receiving sensor input and controlling the heating element; the heating control driver managing power delivery to the heater integrated in the smart heated platform (20); the microcontroller (71) serving as the central processing unit coordinating all system functions; the wireless module providing WiFi/Bluetooth connectivity for smartphone app communication; the power management circuitry handling battery charging, power distribution, and USB-C charging port (72) interface; and the rechargeable battery providing system power, with signal paths showing: IR sensor signals flowing to the microcontroller, heater control signals from thermal management to the heating driver, charging signals and power flow between components, and wireless communication between the microcontroller and external smartphone app for remote monitoring and control of temperature, flame status, and system settings.

Shown in this example are smart heated platform (20), flame sensor(s) (26), drip sensor(s) (27), thermal management circuitry, heating control driver, microcontroller (71), power management circuitry, USB-C charging port (72), wireless module, battery (73). Signal and power flow paths are shown.

FIG. 9 shows a perspective view of a modular scalability illustration showing different sizes of platforms/platforms (10) paired with their compatible interchangeable wax collector chambers (30) connected by dashed lines.

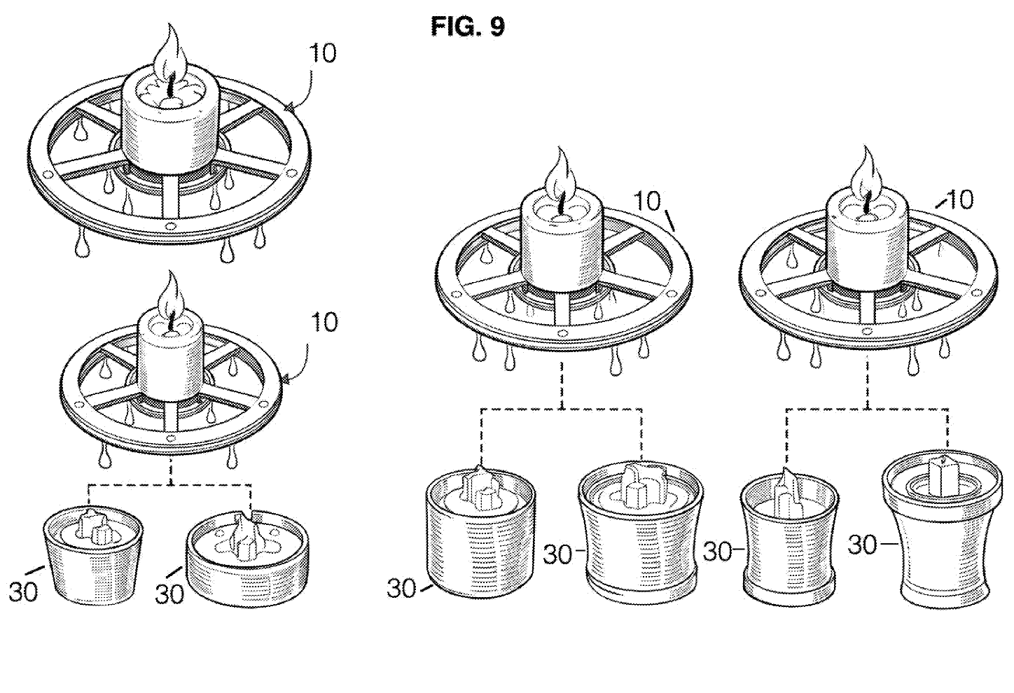

Shown in this example are 5-inch and 3-inch platform platforms shown with candles seated. Four interchangeable collector base sizes: 3" base, 3.5" base, 1" base, 2" base. Dashed lines connect each platform to compatible collector bases. Non-stick wax collector bases demonstrated for producing different sized new candles.

FIG. 10 shows three alternative platform embodiments of the candle regeneration system, illustrating that the invention is not limited to any particular number of spaced arms. From left to right: a three-spoke platform embodiment having three spaced arms with flame detection sensor (26) and drip detection sensor (27) positioned within the platform and drainage openings between the spokes directing molten wax downward into a tapered candle-receiving collector; a five-spoke platform embodiment similarly configured with sensor positions (26) and (27); and a six-spoke platform embodiment with sensor positions (26) and (27) shown at the platform perimeter. Each embodiment is shown with a tapered one-inch candle-receiving collar below. The number of spaced arms may vary from two or more depending on the desired structural configuration, viewing area, and drainage characteristics.

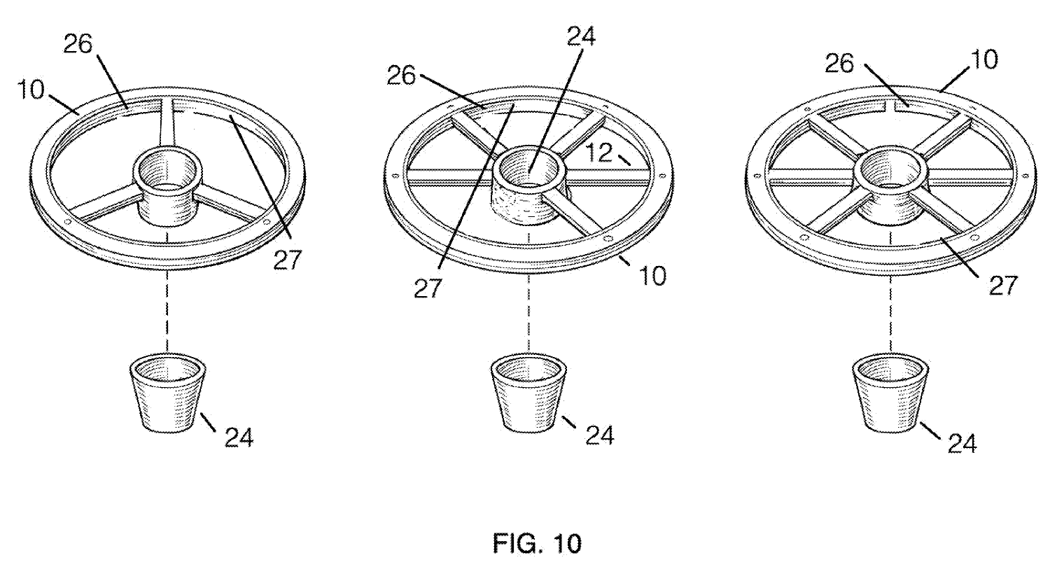

Shown in this example are three platform alternatives shown side by side: 3-spoke, 5-spoke, and 6-spoke, each with a tapered 1" candle cup below. Sensor positions (26) and (27) labeled on each platform. Examples include: three spoke, five spoke and six spoke platform alternatives with tapered candle cups.

FIG. 11 shows a perspective view of a cinnamon stick jar candle with wax dripping from its open bottom alongside a six-spoke platform.

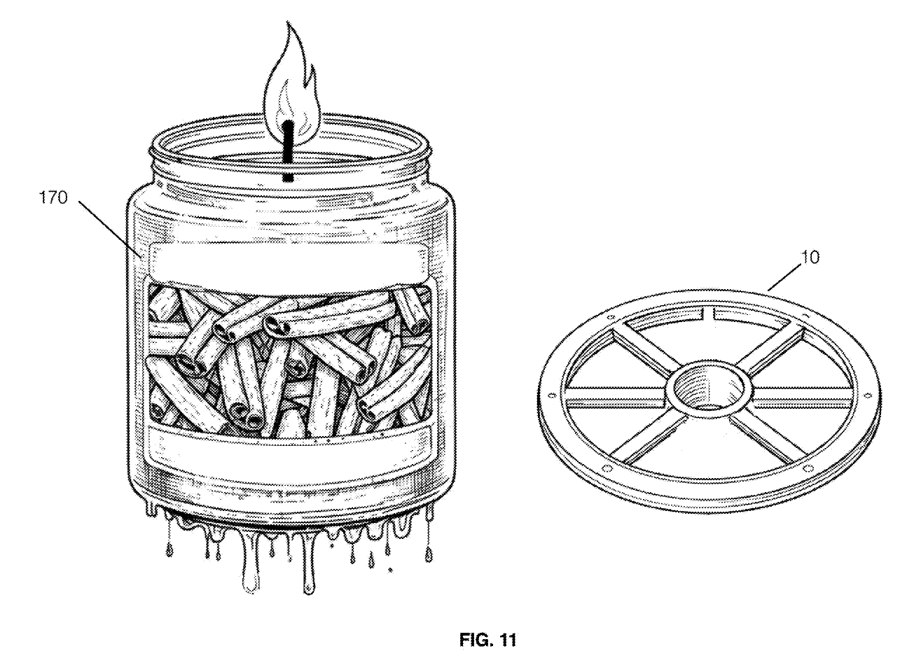

Shown in this example are jar candle (170) showing wax dripping from open bottom, alongside open-bottom platform with six spokes and hub. Cinnamon Stick scented jar candle illustrated as representative commercial jar candle product. Also shown is the open bottom platform.

FIG. 12 shows a perspective view of two sequential actions: the left shows hand inserting wick into wick channel (141) of solidified regenerated wax candle; the right shows completed insertion with wick standing centered. Layered wax texture shows layer-by-layer gravity formation.

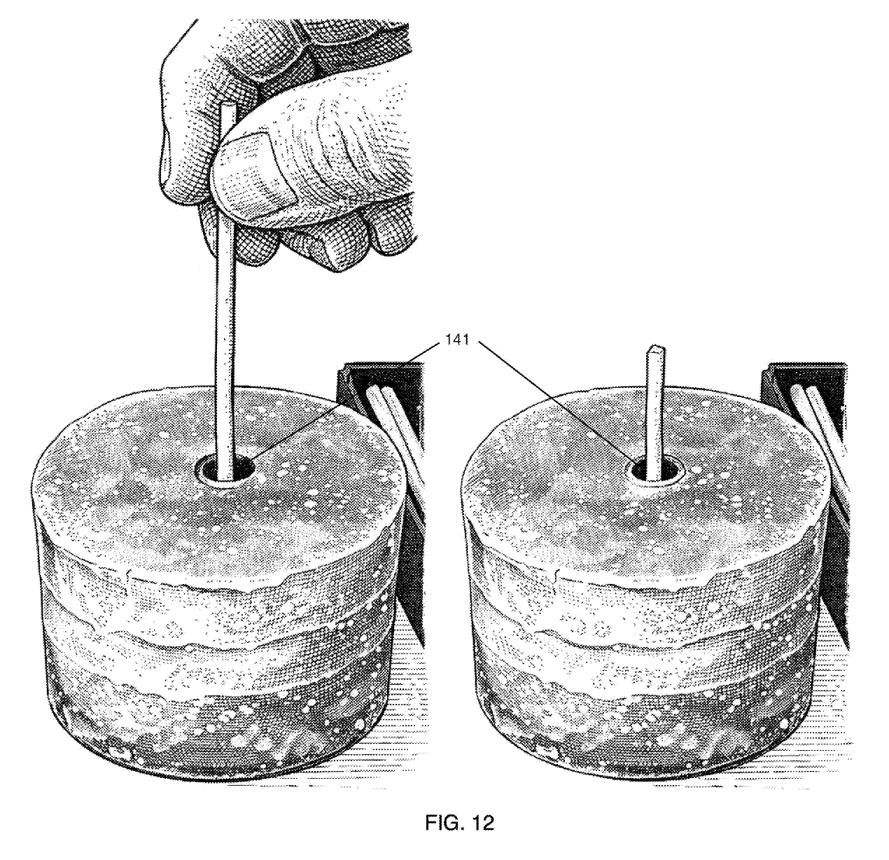

FIG. 13 is an exploded view of a version configured for any candle where on the left: hand removing center wick positioning member (18) upward from wax-collecting chamber with platform attached — Remove the center wick positioning member. On the right: hand tilting collection chamber to extract a regenerated candle.

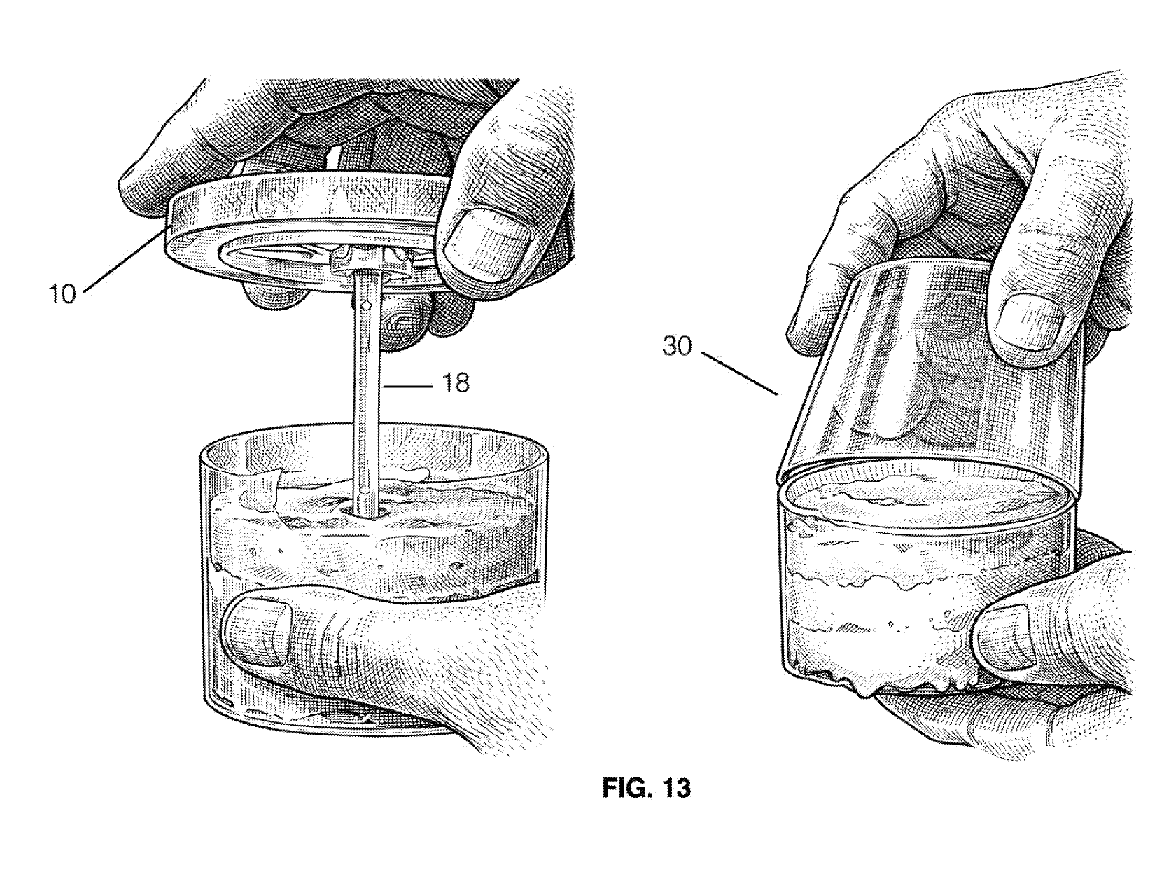

FIG. 14 is four perspective views: Ridges and lips to help guide the dripping wax down and into collection chamber rather than across and get stuck. The platform is held from above and side showing hub and spoke geometry; cross-section detail of raised lip profile; cut-away CAD view with openings for easy wax-collecting and drain holes.

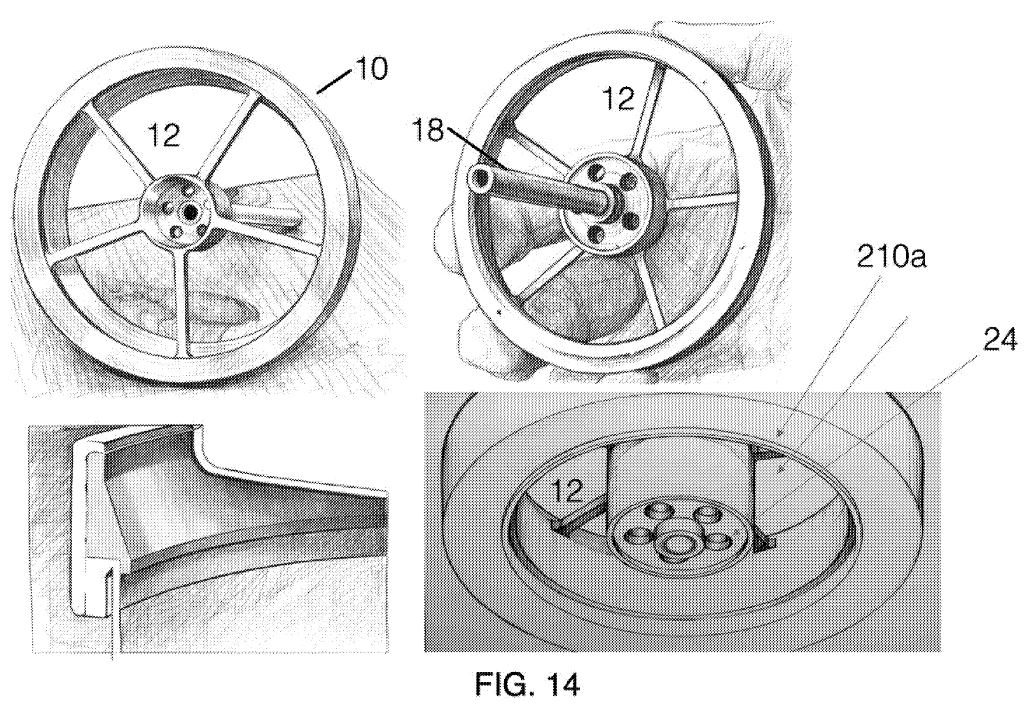

FIG. 15 is a perspective detail view of the platform (10) and wax-collecting chamber (30), illustrating the tapered wax collector (195) which functions as a funnel to channel molten wax from the platform diameter to the collection point. The figure also shows the wick positioning member (18) mounted to the central hub (16), the drainage openings (24), the outer rim (14), the base ring (100), and the PTFE coating optional (180) applied to the surfaces contacting molten wax. Element (210a) identifies the inner drip-guide lip of the platform, which corresponds to the wax-channeling ridge detail shown in FIG. 14 and directs molten wax inward toward the drainage openings and into the wax-collecting chamber below.

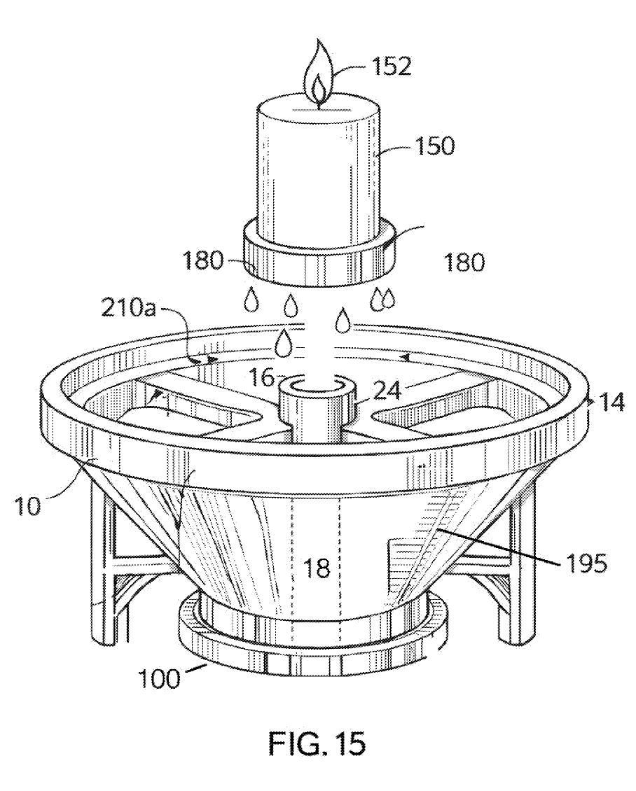

Shown in this example are pillar candle (150), flame (152), PTFE coating (180) at candle-receiving collar and platform surfaces, inner drip-guide lip (210a), hub (16), drainage openings (24), outer rim (14), Platform (10), base ring (100), tapered wax collector (195), wick positioning member (18).

FIG. 16 is a bottom view of a candle container embodiment showing the open-bottom configuration with a candle retention structure. The outer container wall (205) surrounds the candle body (206). A continuous peripheral retention rim (207) of thin malleable material, such as aluminum, is secured to the lower perimeter of the container, supporting the candle body within the container while leaving the central area fully open to permit molten wax to drain downwardly into the wax-collecting chamber below. The invention is not limited to a continuous rim; any retention structure positioned at the lower perimeter of the container — including spaced arms, mesh, pins, a crimped foil ring, or partial rim segments — may be used to support the candle while permitting wax drainage.

Shown in this example are bottom view showing outer container wall (205), candle body open area (206) and peripheral retention rim (207).

FIG. 17 is an exploded perspective diagram illustrating a candle support platform (10) including spaced support elements (14) defining open drainage regions (16) through which molten wax flows downward into a separably connected wax-collecting chamber (30).

Shown in this example are:
10 — Platform assembly;
12 — Outer support ring;
14 — Spaced support elements;
16 — Open drainage regions;
19 — Candle body (shown in phantom);
25 — Non-stick interior surface;
28 — Wax collection volume;
29 — Platform-to-collector connection interface;
30 — Wax-collecting chamber. Flow arrows indicating molten wax movement downward through drainage regions are intentionally left unnumbered per USPTO drawing practice.

It should be appreciated that the specific dimensions, angle degrees, temperatures, materials, chemistries, alloys, colors are specific details are included infra and supra are intended to be enabling and not limiting. A wide variation of these parameters are interchangeable and may be well outside the specific parameters indicated and still fall well within the scope of the inventive concept and are variable and adjustable as would be apparent for the specific application and market and use to best carry out the obvious inventive intention.

### DETAILED DESCRIPTION OF THE INVENTION

### Core Mechanical System

### Gravity-driven Layer-by-layer Formation

A critical aspect of the invention is the use of gravity to form a perfect regenerated candle slowly, layer by layer, in different size diameters determined by the collection chamber geometry. As the original candle burns, molten wax drips through the spoke gaps and falls into the collection chamber maintained at ambient temperature. The wax solidifies from the bottom up in concentric layers, with each drip creating thin layers that build progressively to form the new candle. This layer-by-layer formation ensures proper wick centering, uniform wax density, and structural integrity of the regenerated candle.

This embodiment represents the simplest, lowest-cost implementation suitable for retail. This version contains no electrical components and operates purely through gravity, thermal conduction from the burning candle flame, and material properties.

### Raised Vertical Lips For Wax Guidance

The platform incorporates raised vertical lips (2-3mm height, 0.5-1mm width) along both longitudinal edges of each spaced support element. These lips function as passive wax-guidance elements in both heated and non-heated embodiments, operating independently of any electrical heating system. The raised lips alter surface tension flow behavior, preventing molten wax from spreading laterally across spoke surfaces, creating controlled droplet release points at spoke ends and gaps. This passive flow control reduces wax loss from 5-8 % (flat spoke design) to less than 2 %, guiding wax toward the central collection area while maintaining clean spoke surfaces for aesthetic viewing. The lip geometry comprises a sharp 90-degree vertical edge with smooth surface finish (Ra 1.6 µm or better) that promotes clean droplet formation and release. Molten wax preferentially flows along the lip boundaries rather than across the spoke face, particularly during high-drip-rate phases when large amounts of wax are melting simultaneously. This mechanical wax-routing feature operates continuously throughout the burn cycle without power consumption, thermal input, or user adjustment.

The platform (10) consists of a circular platform with five spaced arms (12) positioned at 72° intervals. The spokes extend from an outer rim (14) to a central hub (16) where the wick positioning member (18) is mounted. This 5-spoke design provides substantial open drainage and viewing area, allowing users to observe the burning candle and accumulated wax in the collector chamber below.

### Wax Shrinkage-assisted Release Mechanism

Wax undergoes volumetric shrinkage during solidification, resulting in radial contraction away from chamber walls and the wick positioning member. This shrinkage creates a natural separation gap that facilitates removal.

Material: Aluminum 6061-T6 alloy

Outer diameter: 87mm (3" version) or 127mm (5" version)

Spoke width: 8-12mm

Spoke thickness: 2mm

Surface finish: Ra 1.6 µm (machined)

Optional coating: Type III anodization (RAL 1004 Golden Yellow) or PTFE seal

The platform serves multiple critical functions:
1. Structural support for the burning candle
2. Wax flow channels (between spokes)
3. Aesthetic viewing (transparent gaps between spokes)
4. Thermal conduction pathway for self-cleaning effect
5. Twist-on connection interface to collector chamber

### wick positioning member

The wick positioning member (18) mounts vertically at the center hub (16) of the platform. Two configurations are provided:

Configuration A (Solid Post):
External diameter: 6mm
Length: 67mm
Material: Aluminum 6061-T6
Threading: M8 external bayonet feature at top (1.5mm engagement)
Purpose: Forms centered wick channel during wax solidification
Coating: PTFE sealed Type III anodization optional

Configuration B (Hollow Post with Internal Channel):
External diameter: 6mm
Internal diameter: 4mm
Purpose: Allows for heater wire insert (optional)
Used in alternative embodiments requiring heat in wick positioning member

The solid post (Configuration A) is preferred for the mass-market embodiment. The post remains stationary as molten wax flows around it and solidifies, creating a precisely centered wick channel approximately 6mm in diameter.

Critical innovation: The post exploits wax shrinkage properties. As wax solidifies, it undergoes volumetric shrinkage, pulling away from the post surface. Combined with optional PTFE coating, this enables the solidified candle to release cleanly from the post when removed from the collector chamber.

### Bottom Drainage Features

The platform includes multiple drainage features to facilitate wax flow:
Primary drainage:
   Five openings between spokes (72° sectors)
Secondary drainage:
   4.5mm diameter holes (quantity:
   5 shown, but could be more or fewer) positioned at 72° intervals around center hub, but could be asymmetrical or at different degree intervals.

Cup seat perforations: Small holes at bottom of candle cup area to allow residual wax drainage during self-cleaning phase

These drainage features work synergistically with gravity to channel melting wax downward into the collector chamber (30) positioned below the platform.

### Twist-On Connection System

The platform (10) connects to the collector chamber (30) via a twist-on bayonet interface (40). This design exploits differential thermal expansion between aluminum and plastic:
Thread specification: Modified bayonet-style, 2mm pitch, 5 thread engagement
Outer thread diameter: 78.4mm
Tolerance: ISO 2768-mK

### Rotation: 60° clockwise to lock, counterclockwise to release

When assembled at room temperature (20° C), the connection provides secure mechanical retention. During operation, the aluminum platform heats from the burning candle (reaching about 40-60° C at the rim), expanding slightly and creating even tighter engagement. Upon cooling after candle extinguishment, differential contraction rates facilitate easy separation.

### Food-grade-like Plastic Collector Chamber

In the primary embodiment, the funnel function is integrally formed as part of the wax-collecting chamber (30/195), whose tapered walls channel all molten wax to the collection point. However, in alternative embodiments, the tapered funnel section may be fabricated as a detachable component configured to connect to the collection chamber via the existing bayonet interface (40) or other suitable means, allowing for modular variation in materials or design.

The collector chamber (30) serves as both the wax collection vessel during operation and the mold for the regenerated candle:
Material: Food-grade-like polypropylene (PP) or polyethylene (PE)
Standard food-grade resin grades suitable for wax contact applications
Wall thickness: 2-3mm
Internal diameter (top): 76mm
Internal diameter (bottom): 51mm (creates 2" diameter regenerated candle)
Height options: 25mm (1" candle), 50mm (2" candle), 75mm (3" candle), 100mm (4" candle)
Taper angle: ~8° for easy release
Bottom: Decorative rim with slightly convex profile

The collector chamber features either inherent non-stick properties (from material selection) or optional PTFE coating on interior surfaces. Critical design consideration: the tapered profile (wider at top, narrower at bottom) combined with wax shrinkage enables the solidified regenerated candle to release from the chamber through simple twist-and-pull action, then squeeze and release new candle.

Candle Removal Process:
1. Twist wax-collecting chamber counterclockwise to disengage bayonet connection from platform which in turn will also take the attached wick positioning member and pull upward to extract post from central channel of regenerated candle
2. Invert collection chamber (turn upside down)
3. Squeeze flexible chamber walls to release regenerated candle

Note that wax shrinkage creates clearance but squeezing is sometimes required for complete release.

Decorative bottom rim: The chamber includes an aesthetic bottom rim that is purely decorative with a structural and functional purpose - to give a wider than 2” base chamber for the system stability. This rim can be injection-molded in various colors materials or finishes to create branded or decorative regenerated candle holder system.

### Assembly and Operation Sequence Mass-Market Embodiment

Initial Assembly:
1. Twist collector chamber (30) onto platform (10) with 60° rotation
2. Place original pillar or taper candle on platform
3. Light candle

During Operation:
4. As candle burns, melting wax drips through platform spoke openings (12)
5. Molten wax flows down around wick positioning member (18) via gravity and surface tension
6. Wax accumulates in collector chamber (30) around the post
7. Post remains centered, creating wick channel as wax solidifies
8. Final burn phase: flame directly heats aluminum platform and post, melting residual wax which drains through bottom perforations into collector chamber

Post-Use:
9. Allow system to cool 2-4 hours for complete wax solidification
10. Twist counterclockwise to separate collector chamber from platform
11. apply gentle twisting and squeezing pressure
12. Regenerated candle releases cleanly with centered wick channel
13. Insert pre-waxed wick into formed channel
14. Regenerated candle ready for use

Estimated active user time: 2.5-3 minutes total over entire cycle

Wax recovery rate: Enhanced collection efficiency

### Observed Self-Cleaning Thermal Effect

An observed advantage: the aluminum platform exhibits a self-cleaning effect during the final burn phase when the wick reaches its end and the flame directly contacts the metal surfaces.

Thermal sequence:
1. As wick burns down to final 5-10mm, flame height increases (excess wax fueling larger flame)
2. Flame directly heats aluminum platform rim and spokes (reaching 150-200° C)
3. Flame-proximity-induced thermal energy conducts through aluminum to wick positioning member (18)
4. Any residual wax adhering to platform surfaces melts (wax melting point: 46-68° C)
5. Melted residual wax flows through drainage perforations into collector chamber (30)
6. Result: Minimal wax residue remaining on platform

This effect achieves substantially complete wax capture in the mass-market passive version without requiring electrical heating elements. The self-cleaning is an inherent property resulting from:
Aluminum's high thermal conductivity (205 W/m·K)
Minimal thermal mass of thin spokes (2mm)
Strategic positioning of drainage holes at hot zones
Direct flame contact during final burn

Prior art candle holders leave residual wax because they lack drainage holes at the bottom of the candle cup area. The present invention's perforated design combined with aluminum thermal properties enables gravity drainage of melted residual wax.

### HEATED EMBODIMENT

The specialty embodiment retains all mechanical features of the mass-market version while adding integrated electronic heating and flame detection for enhanced wax recovery and user experience.

### Integrated Heating Element

A nichrome heating wire (50) is integrated in the platform (12) during manufacturing:
Wire specification: Nichrome 80 (80 % Ni, 20 % Cr)
Wire diameter: 0.4-0.6mm
Resistance: 12-18 ohms total
Power: 3.5-5.0 watts at 3.7V (single Li-ion cell)
Configuration: Series connection through all five spokes

Thermal zones created:
Zone 1 (Primary): Platform surface - 65-95° C depending on mode
Zone 2 (Secondary): wick positioning member - 55-75° C via conduction
Zone 3 (Tertiary): Bottom plate - 45-60° C via extended conduction

### The heating element serves two distinct functions controlled by flame and optional drip detection

Mode 1 - Drip Maintenance (Active Burning / drip detected):
Target temperature: First temperature range at platform surface
Purpose: Keep dripping wax fluid for optimal flow
Power level: 40-50 % duty cycle PWM
IR sensor state: Flame detected / drip detected

Mode 2 - Residual Elimination (Post-Extinguish):
Target temperature: Second elevated temperature at platform surface
Purpose: Melt all residual wax remaining after wick burnout
Power level: 90-100 % continuous
Duration: Programmed duration after flame extinction detected
IR sensor state: No flame detected, wax present

Heating element integration preferably includes optional PTFE coating on all aluminum components to prevent wax adhesion at elevated temperatures.

### Flame Detection and Drip Detection Systems

A flame detection sensor module (60) mounts to the platform with direct line-of-sight to the wick flame location:
Sensor type: Photodiode sensitive to 760-1100nm (flame emission spectrum)
Mounting position: Embedded in platform, angled 15° toward center
Detection range: 50-150mm (covers standard candle heights)
Sampling rate: 10 Hz
Processor: Microcontroller with adaptive threshold algorithm

### Multi-State Detection Logic

State A - Candle Burning/drip detected:
IR intensity > threshold + 20 % margin
Action: Maintain Mode 1 heating (first temperature range)
Status LED: Solid green

State B - Candle Extinguished (Wax Remaining):
IR intensity < threshold
Thermal sensor confirms temperature drop
Action: Switch to Mode 2 heating (second elevated temperature) for residual elimination
Duration: Programmed duration then auto-shutoff
Status LED: Pulsing amber

State C - Candle Finished (Complete Wax Depletion):
IR intensity < threshold AND thermal plateau detected
Action: Complete system shutdown
Status LED: Off

State D - Standby (No Candle):
IR baseline reading, no thermal activity
Action: System sleep mode
Status LED: Off

The detection system eliminates the need for user intervention - the system automatically transitions between heating modes based on candle state, maximizing wax recovery while minimizing power consumption.

### Temperature Management System

A thermocouple or thermistor (74) mounts at the platform rim to monitor surface temperature:
Sensor type: K-type thermocouple or NTC thermistor
Sampling rate: 1 Hz
PID control parameters: Kp=2.0, Ki=0.5, Kd=0.1
Overheat protection: Hard cutoff at 105° C

The microcontroller implements closed-loop temperature control, adjusting PWM duty cycle to maintain target temperatures despite varying ambient conditions and thermal loads.

### Power System

USB-C port (5V input) or 3.7V Li-ion cell (18650 format, 2500mAh typical)

Battery runtime: Extended operation of active heating

Charging circuit: TP4056 or equivalent, 500mA charge rate

Low battery indicator: LED flashes red below 3.3V

### Enhanced Performance Specifications

The specialty heated embodiment achieves:
Wax recovery rate: Substantially enhanced through heat-assisted extraction compared to passive collection
Residual wax remaining: <2 % (compared to passive embodiments)
Automatic mode switching eliminates user monitoring
Maintains optimal drip temperature throughout burn

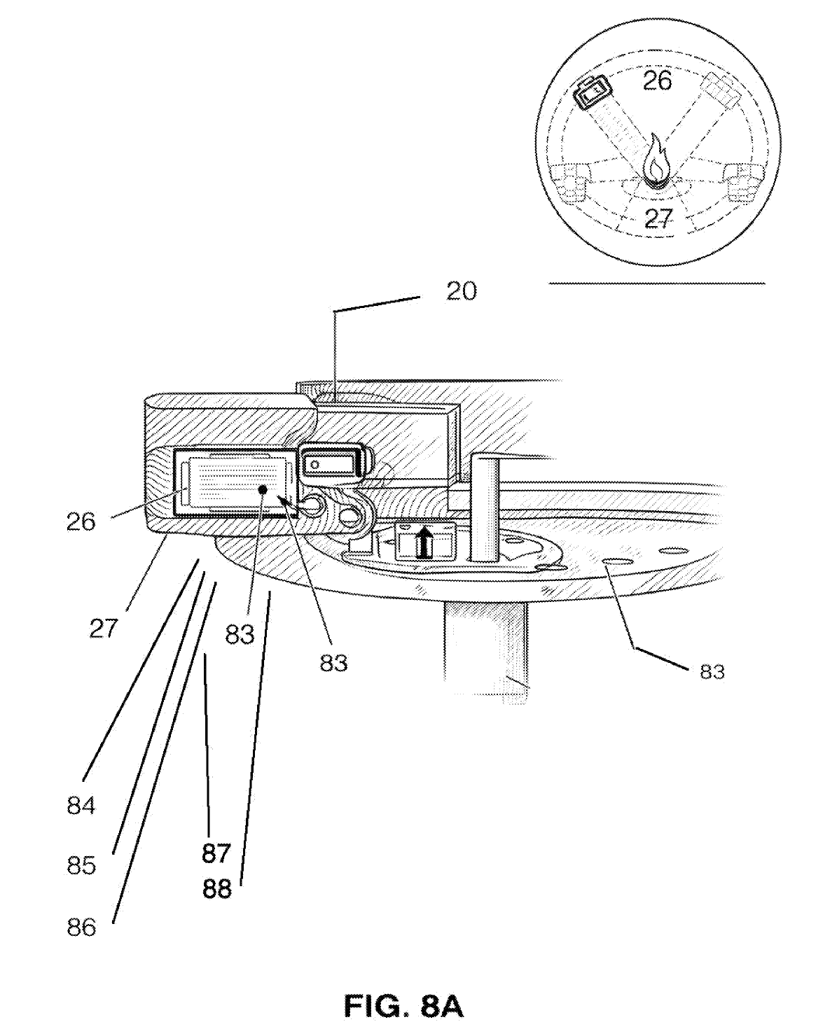

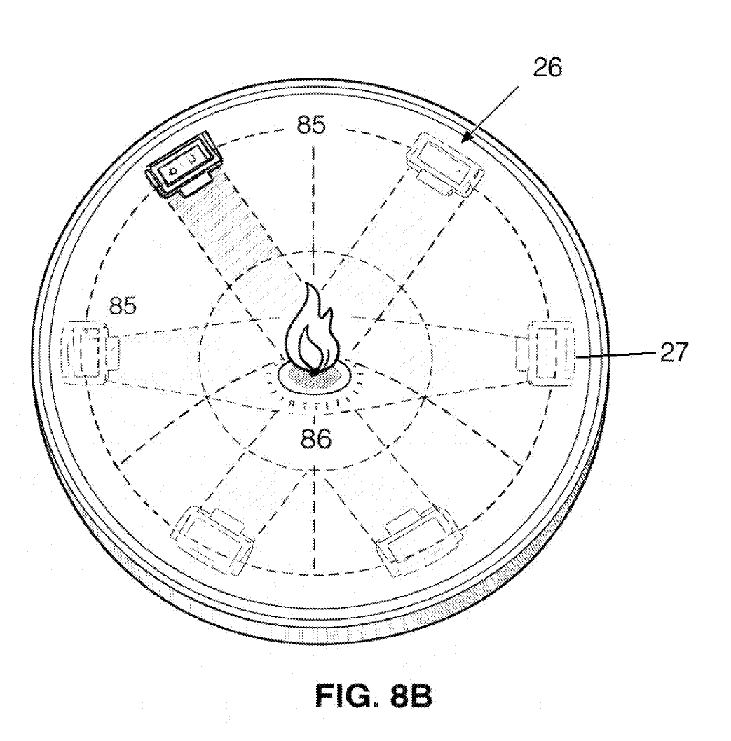

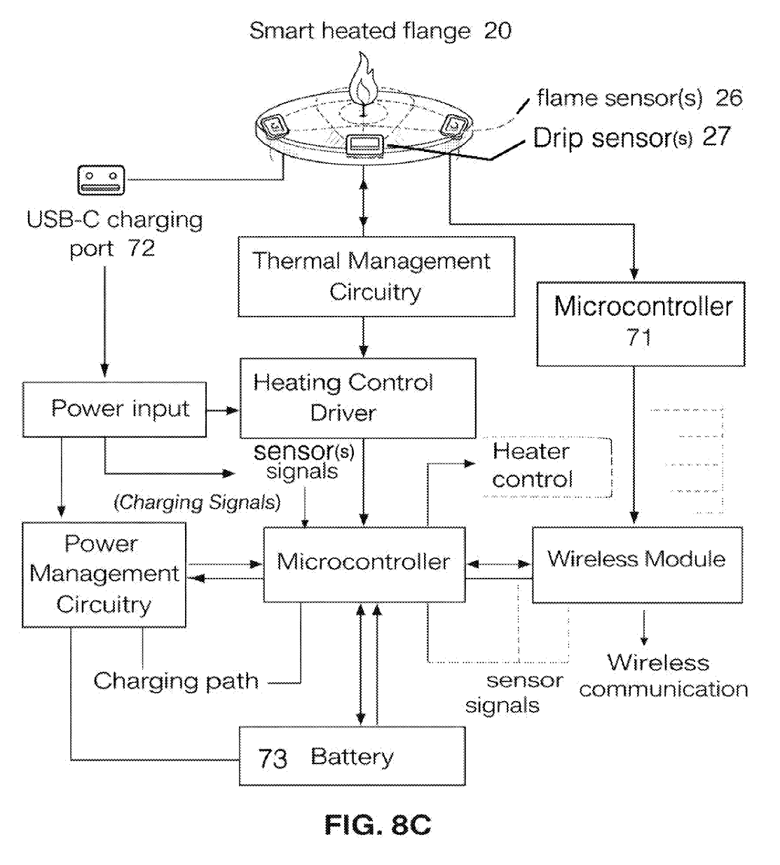

SMART HEATED platform WITH FLAME AND DRIP DETECTION (FIGS. 8A, 8B, 8C)The smart heated platform (20), also referred to herein as the heated embodiment of platform (10), incorporates automatic flame and drip detection using at least one flame detection sensor (26) to optimize wax recovery and regeneration. As shown in FIG. 8A, the smart heated platform (20) integrates the flame detection sensor (26) within the platform structure for monitoring candle combustion. The sensor is housed in a precision-machined sensor cavity (83) formed in the platform housing, with an IR-transparent window (84) providing optical access to the flame while protecting the sensor from direct heat and combustion byproducts. Each flame detection sensor (26) has a defined field-of-view cone (85) oriented toward the flame detection zone (86), which encompasses the area above the platform center where the candle wick and flame are located during normal operation.

The flame detection sensor (26) may comprise any sensing technology capable of detecting the presence or absence of a candle flame, including but not limited to infrared sensors, visible light sensors, cameras or imaging devices, photodiodes, ultraviolet flame sensors, or thermal sensors. The figure includes a top view inset showing the arrangement of sensor positions around the platform perimeter, with one sensor (26) shown in solid lines and additional sensor positions indicated in phantom lines to illustrate the flexibility of single or multiple sensor configurations (one or more sensors may be used). A second sensor cavity is shown adjacent to the flame sensor cavity, housing a drip detection sensor (27) positioned with its field-of-view or detection zone (88) oriented downward toward the drainage openings (24) between the spokes, detecting the presence or absence of molten wax flow through the spoke gaps. The drip detection sensor (27) may comprise any sensing technology capable of detecting wax flow, including but not limited to infrared optical sensors, visible light sensors, cameras or imaging devices, photodiodes, capacitive sensors, or ultrasonic sensors. The drip detection sensor generates a multi-state signal distinguishing between an active drip state and a no-drip state, providing the controller with real-time confirmation of wax drainage during burning and after wick burnout.

Electrical signals from the sensor are transmitted via connection path (87) to the electronics platform (70) for real-time processing and system control. The flame detection sensor (26) may comprise any detection technology capable of sensing flame presence, including but not limited to photodiode-based sensors, thermopile sensors, pyroelectric sensors, infrared sensors, visible light sensors, cameras, or integrated sensing modules.

As illustrated in FIG. 8B, the smart heated platform (20) may be configured with one or more flame detection sensors depending on performance and reliability requirements. In the basic embodiment, a single flame detection sensor (26) positioned at any point around the platform perimeter provides adequate flame detection for triggering the dual-stage heating sequence. The sensor continuously monitors for three key conditions: (1) steady flame presence during normal burning, (2) flame flicker indicating wick depletion or instability, and (3) flame extinction when the wick has been fully consumed. For enhanced reliability and coverage, the platform may incorporate multiple flame detection sensors distributed around the perimeter. The system is fully operable with a single flame detection sensor (26), and additional sensors are optional and may be included for redundancy or expanded detection coverage.

FIG. 8B shows optional sensor positions indicated in phantom lines, demonstrating that multiple sensors may be installed in sensor cavities (83) positioned at regular intervals around the platform circumference. Multiple sensors provide redundancy (if one sensor fails, others continue operation), improved detection accuracy (signal comparison among sensors may reduce false positives), and broader coverage (overlapping detection zones ensure flame visibility from multiple angles). The number of sensors may be selected based on application requirements. Cost-sensitive consumer products may utilize a single sensor, while premium or commercial applications may employ multiple sensors for maximum reliability. The platform housing is designed with multiple pre-positioned sensor cavities (83) so that a single platform design can accommodate various sensor configurations without tooling changes.

FIG. 8C presents the system block diagram showing integration of the flame detection sensor(s) (26) and drip detection sensor(s) (27) with other electronic subsystems. Sensor signals are processed by the microcontroller (71), which implements flame detection algorithms to distinguish between normal flame flicker and actual extinction. During normal burning, the thermal management circuitry maintains the platform at a first temperature sufficient to facilitate wax flow through the drainage channels without premature solidification. When the microcontroller detects flame extinction and wax dripping through the IR sensor input, it triggers the automatic final extraction sequence. The heating control driver increases power to the heating element embedded in the platform, raising the temperature to a second elevated temperature for a programmed duration sufficient to extract residual wax remaining in the candle body and on the platform surface, driving it through the drainage openings (24) into the collection chamber below. This automated process enables substantially greater wax recovery compared to passive embodiments. The wireless module enables remote monitoring and control through a smartphone app (80). Users can view real-time flame status, adjust heating temperatures and durations, set automatic shutoff timers, and receive notifications when candle regeneration is complete.

The rechargeable battery (73) powers the system, with USB-C charging ports (72) providing convenient recharging. Battery life varies depending on heating intensity and wireless usage. Certain embodiments described herein integrate IR flame drip detection with automated heat-assisted extraction. For example, certain passive drainage systems do not incorporate active heating or automated flame detection. Other candle warming devices may apply heat to re-melt an already formed candle, but do not integrate real-time flame detection with dual-stage heating control during active combustion and post-extinction extraction. IR Sensor Components(83) Sensor cavity - Recessed housing in platform perimeter for mounting flame detection or drip detection sensor; may be populated with sensor or left empty for optional configurations(84) IR-transparent window - Optical window material allowing infrared radiation from flame to pass through to sensor while protecting sensor from heat and debris(85) Field-of-view cone - Angular detection range of IR sensor defining the sensor's coverage area(86) Flame detection zone - Monitored area above platform center where flame presence, intensity, and extinction are detected by one or more IR sensors(87) Electrical connection path - Wiring harness routing sensor signals from IR sensor(s) (26) to electronics platform (70)(88) Drip detection field-of-view or detection zone - Angular detection range of drip detection sensor (27) oriented downward toward drainage openings (24) between spokes (89) Optional sensor position - Additional sensor cavity locations around platform perimeter for multi-sensor configurations (shown in phantom lines in drawings)Dual IR Sensing System: The heated embodiment employs (1) IR flame detection sensor (detects on/off state), and (2) drip detection sensor (monitors wax dripping, triggers heating when drip detected, applies periodic heating if drip missed to maintain wax flow).

### FOOD-GRADE-LIKE NON-STICK MATERIALS AND COATINGS

PTFE (Polytetrafluoroethylene) Coating optional.

Primary optional non-stick coating for aluminum components:
Application method: Spray coating with heat cure
Layer thickness: 25-50 microns
Temperature stability: Continuous use to 260°C
Non-stick properties: Contact angle 110-120°

Coating coverage zones:
Platform top surface (candle contact area)
wick positioning member entire surface
Interior of collector chamber (if aluminum version)

Surface preparation requirements optional:
1. Degrease with isopropyl alcohol
2. Abrasive blast with aluminum oxide media (120 grit)
3. Apply PTFE primer coat
4. Apply PTFE topcoat (2-3 layers)
5. Cure at 380-400° C for 10-15 minutes

Expected durability: 50+ regeneration cycles before re-coating needed

FVMQ (Fluorosilicone) Coating on Glass is optional.

For specialty embodiments using transparent borosilicate glass collector chambers:
Material: Fluorosilicone rubber (FVMQ) or FEP film.
Application: Dip coating or spray application
Layer thickness: 50-100 microns
Temperature stability: Continuous use to 200° C
Optical properties: Maintains high transparency
Non-stick properties: Contact angle 105-115°

Advantage: Provides non-stick properties while maintaining optical clarity for viewing the regenerated candle formation process.

### Food-Grade-Like Plastic Materials

For plastic collector chambers and potential all-plastic embodiments:

Option 1 - Polypropylene (PP):
Melting point: 130-171° C
Inherent non-stick properties
Cost: $0.15-0.30 per chamber (injection molded)
Suitable for: Collector chamber in all embodiments

Option 2 - Polyethylene (PE):
Melting point: 120-135° C (HDPE)
Good chemical resistance
Cost: $0.12-0.25 per chamber
Suitable for: Collector chamber, non-heated areas only

Option 3 - Food-grade-like silicone:
Temperature range: -40° C to 230° C
Excellent non-stick properties
Cost: reduced per chamber
Suitable for: Flexible collector chambers (premium versions)

### Material Selection Decision Matrix

Lower cost options may use: - Aluminum platform: Anodized (no PTFE coating) - cost savings - wick positioning member: Anodized aluminum (no PTFE) - cost savings - Collector chamber: PP or PE plastic (no coating needed)

Higher quality and cost options may use: - Aluminum platform: PTFE-coated components preferred for heating) - wick positioning member: PTFE-coated components preferred) - Collector chamber: Borosilicate glass with FVMQ coating OR PTFE-coated aluminum

### ALTERNATIVE EMBODIMENTS AND VARIATIONS

### Three-Part All-Plastic System

An ultra-low-cost embodiment utilizes food-grade-like plastic for all components, for example:
Component 1: Plastic platform with spokes (injection molded PP)
Component 2: Plastic wick positioning member (injection molded PP)
Component 3: Plastic collector chamber (injection molded PP)

Limitations: May not be best used with heated embodiment (plastic would melt). Suitable more for passive gravity collection. Lower thermal conductivity reduces self-cleaning effect.

### Two-Part Simplified System

Combines platform and wick positioning member into single molded component:
Component 1: Integrated platform-post assembly (aluminum or plastic)
Component 2: Collector chamber

Advantages may be reduced parts count, lower assembly cost, no bayonet-style twist-lock connection between post and platform.

### Hybrid Material Combinations

The modular design permits various material combinations:
Configuration A: Aluminum platform + Plastic post + Plastic chamber
Configuration B: Aluminum platform + Aluminum post + Glass chamber
Configuration C: Plastic platform + Plastic post + Aluminum chamber
Configuration D: All aluminum (platform, post, chamber)

Each configuration offers different cost/performance tradeoffs suitable for specific market segments.

### Modular Size Variants

The core design scales to multiple sizes:
Compact (2" platform): Suitable for votive and tea light candles
Standard (3" platform): Optimal for standard pillar candles
Large (5" platform): Premium decorative candles
Commercial (7" platform): High-volume commercial candles wick positioning member diameter approximately 6mm (wick-sized); regenerated candle diameter approximately 2" for standardized regenerated candle output. Sizes will vary depending on other components and application.

### Multiple Chamber Depths

Interchangeable collector chambers in various heights:
1" chamber: Creates short votive-style regenerated candle
2" chamber: Standard regenerated pillar candle
3" chamber: Tall regenerated pillar candle
4" chamber: Extended regenerated candle

Users can select chamber depth based on desired regenerated candle size. Shallow chambers fill faster (fewer source candles required), while deep chambers produce larger regenerated candles.

### ADDITIONAL EMBODIMENTS AND ALTERNATIVES

### I. Glass Jar Candle Regeneration System

### Background

Glass jar candles represent a substantial segment of the candle market. A common inefficiency in traditional jar candles is incomplete wax consumption. Incomplete wax consumption is inherent to jar candle geometry. As the wick shortens, the flame cannot reach wax adhering to sidewalls. Jar geometry prevents the melt pool from expanding to consume peripheral wax. This is not a defect but rather a fundamental limitation of the jar candle format. After the wick burns out, a substantial portion of wax typically remains adhered to the jar walls and bottom. This residual wax represents both economic waste for consumers and environmental waste when jars are discarded.

The present invention addresses this problem by providing a jar candle configuration that enables substantially complete wax recovery through integration with a regeneration system.

### JAR CANDLE EMBODIMENT

### System Components

Base Unit with bayonet interface (100)

Bottomless Jar Candle Configuration (30)

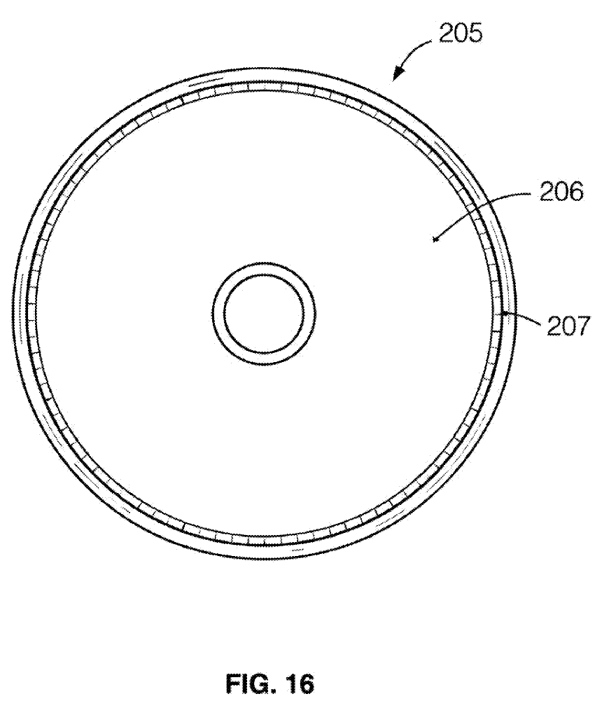

Candle Retention Structure: In various embodiments, the candle container may employ different retention structures at its lower perimeter to support the candle body while permitting molten wax to drain freely into the collection chamber. In a preferred embodiment illustrated in FIG. 16, a continuous peripheral rim (207) of thin malleable material such as aluminum is secured around the lower perimeter of the container (205), crimping or folding inward to retain the candle body (206) while leaving the entire central area open for wax drainage. Alternative retention structures include spaced arms, mesh or grid structures, retention pins, partial rim segments, or any other structure that supports the candle at its perimeter while maintaining an unobstructed central drainage path. The invention is expressly not limited to any particular retention geometry, and any structure achieving candle support with central wax drainage is within the scope of this disclosure.

A candle container is manufactured with an open bottom featuring a grid or mesh structure rather than a solid glass bottom. The grid structure serves multiple functions:

Structural Support: The grid maintains sufficient rigidity to support the wax column within the jar during shipping, handling, storage, and use while the candle burns. Grid design provides adequate strength without excessive material, balancing structural requirements with drainage functionality.

Wax Drainage: Grid openings allow molten wax to flow downward from the jar interior into a collection chamber positioned below. Opening size is selected to permit free wax flow while preventing wick or large debris passage. In some embodiments, opening size ranges from 2mm to 10mm. In certain embodiments, opening size is 2-5mm.

Wick Support: The grid includes structural features that maintain wick positioning during candle manufacturing and initial use. This may comprise a center reinforcement, a thickened grid region, or an integrated wick holder.

Aesthetic Considerations: The grid pattern may incorporate decorative elements including geometric patterns, radial designs, concentric circles, or other visual features. In some embodiments, the grid may include branding elements such as logos or text.

### Grid Material Options

The grid structure may be fabricated from various materials suitable for contact with molten wax and capable of withstanding repeated thermal cycling:
Stainless steel mesh: Food-grade-like austenitic stainless steel (such as 304 or 316 series) provides corrosion resistance, strength, and temperature stability. Mesh may be woven or perforated.
Aluminum mesh with protective coating: Aluminum provides good strength-to-weight ratio. A protective coating such as PTFE or anodization may be applied to enhance corrosion resistance and non-stick properties.
Food-grade-like silicone mesh: Provides flexibility and excellent non-stick properties. Suitable for jars where some grid flexibility is acceptable or desirable.
Perforated glass or glass frit: For premium applications where, all-glass construction is desired. May be formed through fusing, sintering, or precision perforation processes.
Hybrid constructions: Combining materials such as metal structural elements with silicone over molding.

### Bayonet twist on and off Attachment System (40)

Secure mechanical connection preventing accidental separation during normal use

Seal sufficient to prevent wax leakage at the interface during typical operation

Tool-free assembly and disassembly enabling convenient jar replacement by consumers

Standardized interface dimensions allowing jars from different sources to fit a common base unit

In alternative embodiments, attachment may be achieved through threaded means or to include screw on and off, bayonet mounts, clamp rings, snap-fit features, or magnetic coupling.

### Universal Jar Size Compatibility (10)

Different jar candle diameter sizes may be accommodated through different platform size systems.

### Wax Collection and Regeneration Process (18)

During jar candle burning, wax behavior differs from traditional solid-bottom jar candles:
Initial Burn Phase: As the candle burns, molten wax pools on the jar candle surface similarly to traditional jar candles. However, unlike traditional configurations where this wax pool re-solidifies against the jar bottom, the grid bottom allows continuous drainage.
Continuous Drainage: Molten wax flows through grid openings into the collection chamber positioned below the jar candle. Flow occurs continuously during burning rather than only after complete wick consumption. The rate of wax drainage is influenced by wax temperature, viscosity, grid opening size and distribution, and other factors.
Residual Wax Management: In certain embodiments, particularly those incorporating heating elements in the base unit, additional thermal energy may be applied after flame extinction to melt residual wax adhering to jar walls, further improving wax recovery. Such heating may be activated manually, automatically via flame detection, or through timed operation.
Wax Recovery Performance: In various embodiments and under differing conditions, wax recovery may range from substantial to substantially complete. Factors affecting recovery include wax composition, jar geometry, grid design, environmental conditions including ambient temperature and airflow, and presence or absence of supplemental heating. In certain embodiments with favorable conditions, recovery may exceed 90 %.
Plastic Separation: Many commercial jar candles incorporate plastic additives to modify burning characteristics. These plastics typically have higher melting points than wax. During the drainage process, wax preferentially melts and drains while plastic components remain largely in the jar, resulting in regenerated wax of potentially higher purity than the original candle wax.

### Refill Considerations (150)

The bottomless jar candle configuration enables a refill-based consumption model:
Initial Purchase: A consumer purchases a base bottomless jar candle unit (one-time acquisition).
Refill Candles: The consumer subsequently purchases replacement jar candles manufactured without solid bottoms. Manufacturing cost for refills may be lower than complete jar candles due to simplified construction.
Economic Model: The refill approach provides potential cost savings for consumers through reduced per-use candle cost, while creating recurring revenue opportunities for candle manufacturers and the base system provider.
Environmental Benefits: The refill model reduces waste by eliminating disposal of partially-consumed jar candles and enabling wax reuse through the regeneration system.

### Manufacturing Considerations (160)

Bottomless jar candle production may employ various methods:
Grid or lip Installation: The grid or lip ring structure may be secured to the jar opening through:
   Adhesive bonding using food-safe adhesives like rated for expected temperature ranges
   Mechanical retention including crimping the grid into a groove formed in the jar rim
   Fusion processes for all-glass grid constructions
   Combination approaches using both adhesive and mechanical retention
   Molded during initial glass forming for new jar designs
   Added post-formation through thread rolling, grinding, or other material-shaping processes
   Provided via a separate component (such as a metal or plastic ring) attached to the jar

Quality Control: Jar candles typically should withstand:
Wax column weight during shipping and handling (typically 200-500 grams for common sizes)
Thermal expansion and contraction during use cycles
Mechanical stresses during consumer handling including jar installation and removal

Compatibility Standards: Widespread adoption may benefit from industry standardization of bayonet specification and interface dimensions.

Manufactured Jar Candles and Tea Lights with Integrated Drainage Platforms (170)

### II. Glass Funnel Component for Wax Flow Guidance

### Technical Problem (200)

In embodiments where a platform or candle support has a larger diameter than the collection chamber, wax dripping at peripheral locations requires guidance to reach the collection chamber opening. Without such guidance, wax may:
Miss the collection chamber opening entirely, resulting in wax accumulation on intermediate surfaces
Flow along unintended paths, reducing collection efficiency - Create maintenance requirements through buildup on components
Reduce overall system wax recovery performance

Funnel Component Solution (210)

An inverted conical funnel component addresses this challenge by providing a continuous wax flow path from the candle support area to the collection chamber opening.

### Funnel Geometry

Upper Opening Diameter: Dimensioned to match or exceed the diameter of the candle support or platform. This ensures that wax dripping from any location within the candle support area enters the funnel. In some embodiments, a small clearance (1-3mm) may be provided to accommodate manufacturing tolerances.

Lower Opening Diameter: Dimensioned to match the collection chamber opening diameter, ensuring captured wax transfers completely into the chamber. In certain embodiments, the lower opening may be slightly smaller than the chamber opening, sitting within the chamber rim.

Wall Taper Angle: The angle between the funnel wall and vertical is selected based on competing considerations:
Shallower angles (20-35° from vertical) provide gentler wax flow and may reduce splashing but require greater vertical space
Steeper angles (35-50° from vertical) create more compact designs but may increase flow velocity

In various embodiments, wall taper angles of 25-45° from vertical provide suitable performance.

Funnel Height: Determined by upper diameter, lower diameter, and wall angle according to geometric relationships. For example, a funnel transitioning from 75mm upper diameter to 50mm lower diameter with 30° wall angle would have a height of approximately 43mm, while the same diameter transition with 45° wall angle would have a height of approximately 25mm.

### Material Specifications (220)

Suitable materials for funnel construction include:
Borosilicate Glass: Provides excellent chemical inertness, thermal shock resistance, transparency for aesthetic appeal, naturally low surface energy promoting wax flow, and easy cleaning. Thermal expansion coefficient of approximately 3.3 × 10⁻⁶ K⁻¹ provides good thermal shock resistance. Continuous use temperature range typically -20° C to +500° C.
Food-grade-like Polymers: Including polycarbonate, polypropylene, or other suitable plastics offering adequate temperature resistance (typically requiring service temperatures to at least 100-120° C), lower cost than glass, reduced breakage risk, and lighter weight. Transparency may be provided in certain polymer selections.
Coated Metals: Aluminum or stainless steel with food-grade-like coatings such as PTFE providing non-stick properties, high thermal conductivity if thermal management is desired, and durability. Opaque construction.
Food-grade-like Silicone: Providing flexibility facilitating cleaning, excellent non-stick properties, good temperature resistance (typically -40° C to 230° C), and resistance to thermal shock.

### Interior Surface Treatment (230)

Surface finish affects wax flow characteristics:
Smooth Finish: Surface roughness of Ra < 0.8 micrometers minimizes wax adhesion and promotes complete drainage. Achieved through polishing, precision molding, or inherent material properties (as with many glasses).
Spiral Groove Pattern: Optional helical grooves may be formed in the interior surface. Groove depth of approximately 0.5-1.5mm and pitch of 8-20mm can guide wax flow in a controlled spiral pattern, potentially reducing pooling and creating visual interest when transparent materials are used.
Non-Stick Coatings: Application of thin PTFE or similar coatings (thickness 10-100 microns) may further reduce wax adhesion. Coating suitable to be able to withstand expected temperatures.

### Funnel Integration (240)

The funnel component interfaces with adjacent components:
Upper Interface: The funnel upper rim may:
   Rest on an outward platform or rim of the candle support assembly
   Engage via twist-lock or bayonet-style connection
   Connect via bayonet engagement
   Attach magnetically in embodiments using magnetic coupling
   Form an integrated single-piece construction with the candle support (discussed below)

Lower Interface: The funnel lower rim may:
Insert into the collection chamber opening with optional seal (such as O-ring or gasket)
bayonet feature into the chamber opening
Rest on the chamber upper rim
Connect magnetically

Integrated Construction: In some embodiments, the funnel and candle support platform are manufactured as a single continuous component, eliminating joints where wax might accumulate. This integrated design is particularly suitable for glass or molded polymer embodiments. Manufacturing techniques may include glass blowing, precision molding, investment casting, or other forming processes suitable for the selected material.

### Drip Edge Feature (245)

The funnel lower rim may include a drip edge, knife edge, or downward projecting lip. This feature reduces wax bridging across the outlet opening by ensuring any adhering wax drips downward rather than forming horizontal bridges. The drip edge may comprise:
A thin downward extension (0.5-2mm) beyond the main rim
An angled surface directing flow inward and downward
A sharp edge preventing wax from traveling along the underside of the rim

### Flow Characteristics (250)

The funnel geometry promotes efficient wax transfer:
Laminar Flow: For typical wax viscosities at operating temperatures (70-85° C), and typical funnel dimensions, flow within the funnel is generally laminar (low Reynolds number), promoting smooth consistent flow without turbulence or splashing.
Collection Efficiency: Properly dimensioned funnels achieve high collection efficiency, with substantially all wax entering the funnel successfully reaching the collection chamber under normal operating conditions.
Residence Time: Wax typically transits from funnel inlet to outlet in less than several seconds, minimizing opportunity for cooling and solidification within the funnel.

### Visual Appeal (260)

When constructed from transparent materials, the funnel provides aesthetic benefits:
Visible wax flow creates engaging user experience
Spiral groove patterns create visually interesting flow effects
Colored waxes from different candles create layered or marbled visual effects during flow
Transparency enhances perception of cleanliness and proper function

### Maintenance (270)

The funnel component is designed for easy maintenance:
Removable from the system for thorough cleaning when needed
Smooth surfaces facilitate cleaning via hot water rinsing or standard dishwashing
Non-stick surface treatments reduce wax adhesion requiring only minimal maintenance
Accessible interior and exterior surfaces for manual cleaning when desired

### Market Diversity (300)

The candle market includes numerous candle formats beyond pillar candles: Votive Candles: Small candles typically 1.5-2 inches in height and 1.5-1.75 inches in diameter, designed for use in votive holders Tea Light Candles: Very small candles typically 0.5-0.75 inches in height and approximately 1.5 inches in diameter, usually contained in thin metal or plastic cups Taper Candles: Tall slender candles typically 8-12 inches in height and 0.75-0.875 inches in base diameter, designed for use in candlesticks A regeneration system accommodating multiple candle types provides broader market applicability and greater utility for consumers who use various candle types.

### 1” taper pillar cup Construction

A vertical tapered socket of appropriate diameter for taper candles

Other geometries as needed for specific candle types sit on platform directly

Drainage Provision: Pillar 1” candle tapered cup maintains wax collection functionality through drainage features such as:
Perforations in the cup base allowing wax flow to the underlying drainage system
Radial channels or slots directing wax toward existing drainage paths in the platform
Open areas or cutouts providing flow paths with minimal restriction

### Material Selection

1” tapered cup may be fabricated from various materials:
Metals with Non-Stick Coating: Food-grade-like aluminum with PTFE or similar coating provides thermal conductivity, durability, light weight, and non-stick properties.
Food-grade-like Silicone: Provides flexibility, inherently non-stick surface, easy cleaning, and good temperature resistance.
Polymers: Food-grade-like plastics such as polypropylene or polycarbonate offer low cost, light weight, and ease of manufacturing. May include non-stick coatings or treatments.
Glass: Premium aesthetic, transparency, naturally non-stick properties, and compatibility with all wax types.

### Votive Candle with open bottom design sits on platform base

Dimensions: diameter of approximately 1.75 inches (44mm) accommodates standard votive candles provides adequate candle support.

Drainage Features: Multiple radial slots or holes in the tea light base allow molten wax to flow through to the underlying drainage system.

### Tea Light Candle with open bottom design sits on platform base

Thermal Management: Tea lights generate relatively high heat in a small area. Our design may incorporate features such as radial fins on the exterior, ventilation openings, or thermal conductivity-optimized material selection rim to manage heat dissipation.

Drainage Features: Tea lights typically burn substantially completely. Small perforations or drainage features accommodate any wax overflow while the primary function is secure tea light retention.

### Taper Candle

Socket Dimensions: Vertical socket with interior diameter of approximately 0.875 inches (22mm) accommodates the most common taper candle base diameter. Socket depth of approximately 0.75-1.25 inches (19-32mm) provides adequate support for the tall candle. In some embodiments, a stepped or tapered socket accommodates multiple taper base diameters (such as 0.75 inch and 0.875 inch sizes).

Retention System: Taper candles may be secured through:
Friction fit with slight interference
Spring-loaded grippers applying gentle inward pressure
Soft insert material (such as silicone) conforming to the candle base

Drainage Features: Taper candles characteristically drip wax down their sides. The cup includes a collection rim or lip at the socket opening that captures dripped wax. Channels direct captured wax through the cup base to the underlying drainage system.

### IV. Pre-Waxed Wick Assemblies

### Background (400)

After removing a regenerated candle from the collection chamber, a wick must be inserted to render the candle functional. The regeneration process creates a centered wick hole through the candle body (formed by the wick positioning member or similar component). However, threading a bare wick through this hole and securing it at appropriate tension presents challenges for average consumers.

Pre-Waxed Wick Assembly Solution (410)

A pre-waxed wick assembly provides a user-friendly wick insertion solution.

### Wick Component (412)

Braided cotton wick in standard sizing appropriate for expected candle diameter. Wick size selection examples:
Small wicks (#1/0 to #2/0): For 1-2 inch diameter candles
Medium wicks (#4/0 to #6/0): For 2-3 inch diameter candles
Large wicks (#8/0 to #12/0): For 3-4 inch diameter candles

The wick is pre-treated with a wax coating providing:
Stiffness for easy insertion through the wick hole without bending or fraying
Priming for immediate lighting without extensive burn-in period
Protection during handling and storage

Wax coating typically comprises low-melt-point paraffin (melting point 50-60° C) applied to achieve substantial saturation of the wick fibers. Coating thickness is generally 0.3-1.5mm. The coating provides rigidity at room temperature but softens and integrates with the candle wax during burning.

### Retention Disc (414)

A disc component at the wick base provides anchoring:
Diameter: Sized to exceed the wick hole diameter by a margin sufficient to prevent passage. Typical disc diameters range from 10mm to 30mm depending on wick hole size.
Material: Thin metal (such as aluminum or tin), rigid plastic, or compressed fiber. Thickness typically 0.3-1.5mm providing sufficient rigidity without excessive bulk.
Attachment: The disc is crimped, adhered, or otherwise secured to the wick at a position near the wick end. Attachment withstands handling and insertion forces without detachment.
Perimeter Features: The disc perimeter may include teeth, serrations, or roughened features providing grip against the wick hole walls, further resisting wick pull-through during candle lighting and initial burning.

### Optional Components

Lower Wick Tab (416): A small metal tab or clip may be attached at the wick bottom end, below the retention disc. Functions include adding weight to assist insertion and providing a handle for wick positioning.

Pre-Measured Length: Wick assemblies are offered in multiple lengths corresponding to common regenerated candle heights. Standard lengths may include 50mm, 75mm, 100mm, and 150mm options. Custom lengths may be available for specialized applications.

Packaging: Individual wick assemblies may be packaged in protective sleeves or containers preventing wax coating damage or contamination. Multi-packs (such as 10-pack, 25-pack, or larger quantities) provide convenience and value. Packaging includes size identification (such as color coding or labeling) indicating appropriate candle diameter.

### Wick Variations (420)

Beyond standard cotton wicks, variations may include:
Wood Wick Assemblies: Thin wood strips (such as cherry, maple, or cedar) creating crackling sounds during burning. Pre-waxed coating adapted for wood substrate. Retention disc adapted to accommodate flat wick profile.
Multi-Wick Assemblies: Two or more parallel wicks maintained in fixed spacing by the retention disc, suitable for large diameter candles (typically 4 inches or greater). Spacing prevents wick interference while providing more even heat distribution.

### V. Interchangeable Mold Inserts

### Background (500)

While a standard cylindrical collection chamber produces functional regenerated candles, decorative shaped candles provide aesthetic variety and customization opportunities.

### Mold Insert System (510)

Interchangeable mold inserts fit within a standard collection chamber to create regenerated candles in various shapes:

### Insert Construction

Outer Sleeve (512): Dimensioned to fit within the inner diameter of a standard collection chamber. May be a slip-fit allowing easy insertion and removal, or may include retention features such as tabs, grooves, or light friction fit.

Inner Cavity (514): Defines the shape of the regenerated candle. Cross-sectional shape may be non-circular including square, rectangular, hexagonal, star-shaped, or other geometric or decorative forms.

Wick Channel Post (516): A projection or post maintains a centered wick hole through the forming candle. Post position, diameter, and height are selected to create an appropriately sized and positioned wick hole.

Material: Inserts may be fabricated from food-grade-like silicone (providing flexibility aiding candle removal), PTFE-coated aluminum (providing rigidity and non-stick properties), food-grade-like plastics, or other suitable materials. Material selection balances ease of candle release, durability, ease of cleaning, and cost.

### Shape Options (520)

Geometric Cross-Sections: Including square, rectangular, hexagonal, triangular, star (various point counts), or other regular or irregular polygons.

Decorative Shapes: Including heart shapes, flower or petal profiles, leaf shapes, or other decorative cross-sections.

Themed Shapes: Including seasonal or holiday-specific forms (such as trees, stars, pumpkins, eggs, or bells) or occasion-specific shapes (such as numerals, letters, or symbols).

Surface Texture: The insert interior surface may be smooth or may include patterns such as vertical ribs, spiral grooves, or embossed designs that imprint corresponding texture onto the candle surface.

### Insert Features (530)

Release Properties: Insert design facilitates candle removal:
Silicone inserts flex, allowing gentle deformation to release the candle
Rigid inserts include slight draft angles (taper) of 1-4° facilitating release
PTFE or similar non-stick coatings minimize adhesion
Release tabs or grips on the insert exterior aid removal from the collection chamber

Durability: Inserts are designed for repeated use, typically rated for 25-100+ uses depending on material and design. Materials and coatings resist staining, maintain dimensional accuracy, and withstand repeated thermal cycling.

Compatibility: Inserts are offered in sizes matching standard collection chamber diameters, ensuring proper fit. In some embodiments, inserts may be compatible with multiple chamber sizes through adjustable or stackable designs.

The foregoing description conveys the best understanding of the objectives and advantages of the present invention. Different embodiments may be made of the inventive concept of this invention. It is to be understood that all matter disclosed herein is to be interpreted merely as illustrative, and not in a limiting sense.

### ADDITIONAL EMBODIMENTS

In one embodiment the wick positioning member is secured to the platform hub via a locking connection configured such that the rotational force applied during removal of the wax-collecting chamber tightens rather than loosens the connection between the wick positioning member and the platform. During prototype testing it was observed that when the wax-collecting chamber is twisted counterclockwise for removal, a loosely connected post will co-rotate with the chamber rather than remaining stationary. The locking connection solves this by ensuring that the chamber removal action self-secures the post-to-platform connection. This locking connection may be achieved through a reverse thread, a locking bayonet, or any similar mechanism whereby the rotational force of chamber removal tightens rather than loosens the post-to-platform connection.

In one embodiment the open drainage regions defined between the spaced support elements represent at least about 40 % of the total platform area, providing substantially unobstructed wax flow from the candle into the wax-collecting chamber below. This substantial open area distinguishes the present invention from prior art drip trays and bobeches that have very small drainage openings, and from prior art collection tubes that have no open spoke geometry whatsoever.

In one embodiment the wax-collecting chamber is housed within a decorative outer shell configured to surround and conceal the chamber while allowing removal thereof. The outer shell may be formed from materials including ceramic, marble, stone, metal, or decorative plastic, while the inner wax-collecting chamber retains its food-grade non-stick interior surface. The outer shell may be formed as a single piece or multiple pieces and is configured to be separable from the wax-collecting chamber to permit removal of solidified regenerated wax therefrom.

The wax-collecting chamber may be removably or separably connected to the platform, the terms being used interchangeably herein to describe a connection that permits tool-free detachment of the chamber from the platform for wax removal and system maintenance. The terms removably connected, removably attached, and separably connected as used in this specification and claims are intended to be synonymous and claim scope should be interpreted accordingly.

A thermally isolating washer (32) is seated on the underside of the flange assembly (10), interposed between the heated flange and the twist connector (40) and wax-collecting chamber (30) to limit conductive heat transfer from the metal flange to the collection chamber. In the heated embodiment, this thermal isolation element is essential to prevent deformation of polymer or food-grade plastic collection chambers. Suitable materials for the thermally isolating washer (32) include polytetrafluoroethylene (PTFE), silicone, or other food-safe thermally resistant materials. Reference number 32 refers to the thermal isolating washer or spacer throughout this specification.

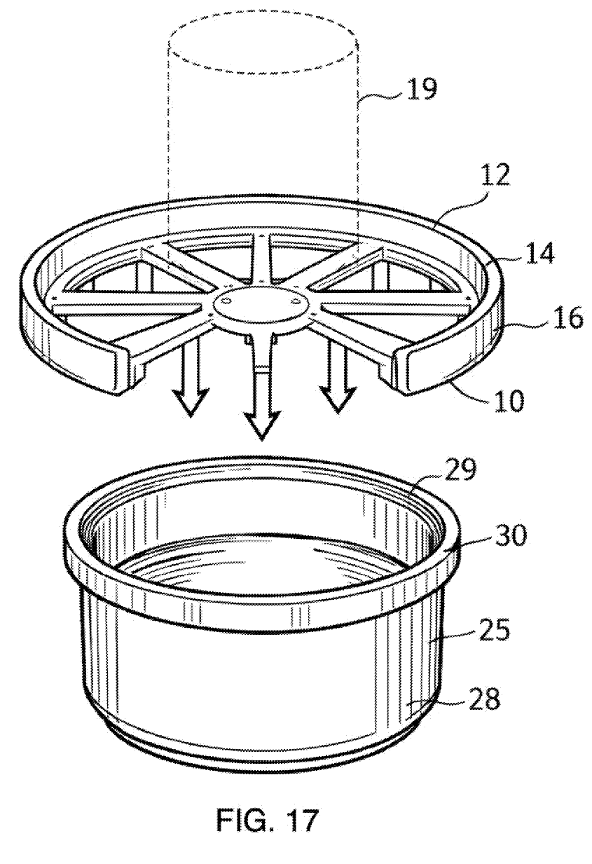

FIG. 17 illustrates a broad drainage architecture embodiment of the invention comprising a platform (10) having spaced support elements (14) defining open drainage regions (16) and a separably connected wax-collecting chamber (30) positioned below the platform. The platform (10) may be removably coupled to the wax-collecting chamber (30) by a connection interface (29). In this embodiment the wick positioning member is not required, demonstrating that the core inventive concept of open drainage geometry combined with a separable collection chamber is operable independently of the centered wick positioning function.

What is claimed is:

1. An apparatus for collecting molten wax from a candle to form a regenerated candle, including a platform able to support a burning candle and having a central area adapted to receive and hold a candle, said platform having a rim portion spaced from said central area, and a plurality of arms spaced from one another and connecting said central area to said rim portion, a wax-collecting chamber positioned below said platform and adapted to receive molten wax dripping from a burning candle and flowing through open areas provided by said spaced arms, a wick positioning member located below said central area and centrally within said wax-collecting chamber and extending towards said central area whereby molten wax dripping from said candle may solidify within said wax-collecting chamber and around said wick positioning member enabling solidified wax collected in said wax-collecting chamber and around said wick positioning member to be removed therefrom with a central hole for placement of a wick to form a candle regenerated from a previously used candle.

2. An apparatus for collecting melting wax from a candle to form a regenerated candle as set forth in claim 1, said rim forming a closed loop and said spaced arms extending to said rim portion.

3. An apparatus for collecting melting wax from a candle to form a regenerated candle as set forth in claim 2, said rim being circular with said spaced arms forming equally spaced spokes connecting said central area to said rim portion.

4. An apparatus for collecting melting wax from a candle to form a regenerated candle as set forth in claim 3, said spaced arms being formed of a thermally conductive material.

5. An apparatus for collecting melting wax from a candle to form a regenerated candle as set forth in claim 4, said thermally conductive material including aluminum with a thermal conductivity of at least 150 W/m·K.

6. An apparatus for collecting melting wax from a candle to form a regenerated candle as set forth in claim 2, said spaced arms being formed of a thermally conductive material.

7. An apparatus for collecting melting wax from a candle to form a regenerated candle as set forth in claim 6, said thermally conductive material being aluminum with a thermal conductivity of at least 150 W/m·K.

8. An apparatus for collecting melting wax from a candle to form a regenerated candle as set forth in claim 1, said wick positioning member being a cylindrical post connected to the underside of said platform beneath said central area.

9. An apparatus for collecting melting wax from a candle to form a regenerated candle as set forth in claim 8, said cylindrical post having a diameter between 4mm and 8mm.

10. An apparatus for collecting melting wax from a candle to form a regenerated candle as set forth in claim 1, said central area including an upstanding platform for receiving and supporting a candle.

11. An apparatus for collecting melting wax from a candle to form a regenerated candle as set forth in claim 10, said platform including spaced openings extending through said platform to allow melting wax to drain therethrough into said wax-collecting chamber.

12. An apparatus for collecting melting wax from a candle to form a regenerated candle as set forth in claim 11, said platform and said spaced arms being formed of a thermally conductive material.

13. An apparatus for collecting melting wax from a candle to form a regenerated candle as set forth in claim 12, said thermally conductive material including aluminum with a thermal conductivity of at least 150 W/m·K.

14. An apparatus for collecting melting wax from a candle to form a regenerated candle as set forth in claim 1, said wax-collecting chamber configured to taper from its connection to said platform to its bottom surface.

15. An apparatus for collecting melting wax from a candle to form a regenerated candle as set forth in claim 14, said wax-collecting chamber being formed from a food-grade plastic material from the group consisting essentially of polypropylene, polyethylene and food-grade silicone.

16. An apparatus for collecting melting wax from a candle to form a regenerated candle as set forth in claim 1, wherein said platform and said wick positioning member have a non-stick coating applied to the surfaces that contact molten wax.

17. An apparatus for collecting melting wax from a candle to form a regenerated candle as set forth in claim 16, wherein said non-stick coating comprises polytetrafluoroethylene.

18. An apparatus for collecting melting wax from a candle to form a regenerated candle as set forth in claim 1, wherein said platform includes a heating element and temperature sensor integrated therein, and a flame detection sensor positioned thereon to detect presence or absence of a candle flame, said flame detection sensor comprising any sensing technology capable of detecting flame presence including infrared sensors, visible light sensors, cameras or imaging devices, photodiodes, ultraviolet flame sensors, or thermal sensors, and a control system configured to operate said heating element in a first mode at a first temperature when said flame detection sensor detects a flame to facilitate flow of melting wax from the candle, and operate said heating element in a second mode at a second temperature higher than said first temperature when said flame detection sensor detects absence of a flame to facilitate extraction of residual wax.

19. An apparatus for collecting melting wax from a candle to form a regenerated candle as set forth in claim 18, said rim portion forming a closed loop and said spaced arms extending to said rim portion and said heating element comprising a resistive wire embedded within at least one of said spaced arms.

20. An apparatus for collecting melting wax from a candle to form a regenerated candle as set forth in claim 19, said platform being formed of a thermally conductive material having a non-stick coating.

21. An apparatus for collecting molten wax from a candle to form a regenerated candle as set forth in claim 18, further comprising a drip detection sensor positioned within or adjacent to the platform and oriented toward the drainage openings between the spaced arms, said drip detection sensor comprising any sensing technology capable of detecting the presence or absence of molten wax flow through said drainage openings including infrared optical sensors, visible light sensors, cameras or imaging devices, photodiodes, capacitive sensors, or ultrasonic sensors, and generating a signal indicating an active wax drip state or a no-drip state, wherein the control system receives said signal and uses it to monitor wax drainage during candle burning and after wick burnout.

22. An apparatus for collecting molten wax from a candle to form a regenerated candle as set forth in claim 1, further comprising: at least one heating element thermally coupled to at least a portion of the platform and configured to selectively apply heat thereto; at least one sensor configured to detect at least one operating condition of the candle selected from the group consisting of presence or absence of a flame, presence or absence of molten wax flow, temperature of the platform, temperature of molten wax, and any combination thereof; and a controller operatively connected to the at least one sensor and the at least one heating element, wherein the controller is configured to: (i) receive one or more signals from the at least one sensor indicating at least one operating condition of the candle, (ii) operate the heating element at a first heating level during active candle combustion to facilitate flow of molten wax into the wax-collecting chamber, and (iii) automatically increase operation of the heating element to a second heating level greater than the first heating level in response to detection of flame extinction while residual wax remains present, whereby residual wax remaining after candle wick burnout is melted and directed into the wax-collecting chamber to increase total wax recovery and enable formation of a regenerated candle.

23. A method of regenerating a candle from wax melted from a prior candle including positioning a candle upon a platform having spaced openings extending under and in the area beyond the perimeter of the positioned candle, positioning a wax-collecting chamber below said platform for receiving molten wax dripping from a burning candle and flowing through said spaced openings, said wax-collecting chamber having a central wick positioning member located below said platform whereby molten wax dripping from said candle may solidify within said wax-collecting chamber and around said wick positioning member enabling solidified wax collected in said wax-collecting chamber and around said wick positioning member to be removed therefrom with a central hole for placement of a wick to form a candle regenerated from a previously used candle.

24. A method for regenerating a candle from wax melted from a prior candle as set forth in claim 23, including said platform being formed of a thermally conductive material allowing the candle flame to heat said platform during final burning of a candle to cause residual wax to flow into said wax-collecting chamber.

25. A method for regenerating a candle from wax melted from a prior candle as set forth in claim 23, wherein said platform includes a heating element, sensing the temperature therein, and detecting the presence or absence of a candle flame, and energizing said heating element in a first mode at a first temperature when a flame is detected to facilitate flow of melting wax from the candle, and energizing said heating element in a second mode at a second temperature higher than said first temperature when the absence of a flame is detected to facilitate extraction of residual wax.

26. A method for collecting molten wax from a jar candle to form a regenerated jar candle as set forth in claim 23, including providing a candle in a holder having a bottom formed by spaced support elements, positioning the jar candle on a platform having drainage openings for melting wax, positioning a wax-collecting chamber beneath said platform and burning the candle.

27. A method for collecting melting wax from a jar candle to form a regenerated jar candle as set forth in claim 26, said spaced support elements being formed of a material from the group consisting essentially of stainless-steel mesh, aluminum mesh with protective coating, food-grade silicone mesh, and perforated glass.

28. A method for collecting molten wax from a jar candle to form a regenerated jar candle as set forth in claim 26, further heating said platform to apply thermal energy melting any residual wax after flame extinguishing of the candle.

29. An apparatus for collecting melting wax from a candle to form a regenerated candle as set forth in claim 1, wherein said platform and said wick positioning member are formed of a thermally conductive material such that during a final burn phase when the candle flame directly contacts said platform, thermal energy is conducted through said platform and said wick positioning member melts residual wax remaining on or adjacent to said platform causing said residual wax to flow through said drainage openings into said wax-collecting chamber, achieving substantially complete wax recovery without requiring electrical heating.

30. An apparatus for collecting melting wax from a candle to form a regenerated candle as set forth in claim 1, wherein said wax-collecting chamber comprises a tapered interior wall with a non-stick surface treatment, said chamber being removably connected to said platform, whereby the combination of said tapered geometry and said non-stick surface is configured to exploit the natural volumetric shrinkage of cooling wax, enabling the solidified regenerated candle to be removed from said chamber by hand pressure alone without tools or mechanical force.

31. An apparatus for collecting melting wax from a candle to form a regenerated candle as set forth in claim 1, wherein said spaced arms define open drainage regions representing at least 40% of the total platform area, providing substantially unobstructed wax flow from the candle into the wax-collecting chamber below.

32. An apparatus for collecting dripping and residual wax from a candle comprising a platform configured to support a candle and including a plurality of spaced support elements arranged to define open drainage regions across the platform through which molten wax from the candle passes downward by gravity and/or with assistance from heat, and a wax-collecting chamber separably connected to the platform below the drainage regions and configured to receive wax passing through the drainage regions, the chamber having an interior surface configured to permit removal of wax solidified therein.

33. An apparatus for collecting melting wax from a candle to form a regenerated candle as set forth in claim 22, wherein a thermally isolating spacer is disposed between the platform and the wax-collecting chamber to limit conductive heat transfer therebetween, said spacer comprising a food-safe thermally resistant material selected from the group consisting of polytetrafluoroethylene, silicone, and equivalent food-safe thermally resistant materials.

34. An apparatus as set forth in claim 32, wherein a thermally isolating spacer is disposed between the platform and the wax-collecting chamber to limit conductive heat transfer therebetween, said spacer comprising a food-safe thermally resistant material selected from the group consisting of polytetrafluoroethylene, silicone, and equivalent food-safe thermally resistant materials.
